(19) United States
(12) Patent Application Publication
(10) Pub. No.: US 2024/0214533 A1
(43) Pub. Date: Jun. 27, 2024

(54) ELECTRONIC DEVICE FOR CAPTURING MOVING IMAGE AND OPERATION METHOD THEREOF

(71) Applicant: SAMSUNG ELECTRONICS CO., LTD., Suwon-si (KR)

(72) Inventors: Junsu CHOI, Suwon-si (KR); Euibum HAN, Suwon-si (KR)

(21) Appl. No.: 18/599,972

(22) Filed: Mar. 8, 2024

Related U.S. Application Data
(63) Continuation of application No. PCT/KR2022/009373, filed on Jun. 30, 2022.

(30) Foreign Application Priority Data
Sep. 9, 2021 (KR) 10-2021-0120620

(51) Int. Cl. H04N 9/89; H04N 5/77; H04N 9/802

(52) U.S. Cl. CPC H04N 9/89; H04N 5/77; H04N 9/802

(57) ABSTRACT

An electronic device obtains first video data by using a camera, obtains first reference data depending on a first schedule during a first time duration by using a microphone, receives first audio data corresponding to the first video data from an external electronic device via a wireless communication circuit, and changes the first schedule to a second schedule based on a comparison result between the first reference data and a portion of the first audio data. The electronic device further obtains second reference data depending on the second schedule during a second time duration subsequent to the first time duration by using the microphone, corrects a delay of the first audio data based on the second reference data, and creates a moving image file based on the first video data and the corrected first audio data.

### CROSS-REFERENCE TO RELATED APPLICATIONS

This application is a continuation application of International Application No. PCT/KR2022/009373 designating the United States, filed on Jun. 30, 2022, in the Korean Intellectual Property Receiving Office and claiming priority to Korean Patent Application No. 10-2021-0120620, filed on Sep. 9, 2021, in the Korean Intellectual Property Office, the disclosures of which are incorporated by reference herein in their entireties.

### TECHNICAL FIELD

Various embodiments of the disclosure relate to a technique of creating a moving image file including audio obtained via an external device.

### BACKGROUND ART

With the recent diversified functions of mobile devices, there is a growing demand for improved photo capturing or moving image capturing functions using the mobile device. Accordingly, the mobile device is capable of performing various moving image capturing functions.

In addition, with the technical advancement, there is ongoing development on various external electronic devices which output audio, based on data received through wireless communication. Such an audio output device may be referred to as a Bluetooth earphone (or an ear bud, headphones, etc.) since it is capable of exchanging data by connecting Bluetooth communication while performing short-range wireless communication with an electronic device (e.g., a mobile device such as a smartphone, a tablet, etc., a laptop, or a Personal Computer (PC)). In a sense that the Bluetooth earphone provides a user with mobility and convenience unlike in the conventional wired earphone, the number of users using the Bluetooth earphone has been recently increasing.

The Bluetooth earphone may not only output audio received through wireless communication but also obtain audio data by using a microphone included in the Bluetooth earphone. When the Bluetooth earphone transmits recorded audio data to the electronic device (e.g., the mobile device) through Bluetooth communication, the electronic device may receive the audio data.

### DISCLOSURE OF INVENTION

### Technical Problem

According to the conventional technique, when an electronic device captures video by using a camera and records audio via a microphone of an external electronic device, there may be a problem in that the video and the audio are not temporally synchronized with each other. While audio data is transferred from the external electronic device to the electronic device, since the transferred audio data is delayed due to a delay or interference caused by a shared wireless communication path, retransmission caused by a data reception failure, or the like, the electronic device may receive audio data not temporally synchronized with video data. Therefore, when the electronic device performs video rendering by mixing the video and audio obtained at different time points, an unnatural moving image file may be created. When the video and the audio are not synchronized, there may be a problem in that a moving image file in which video and audio are not synchronized is obtained.

According to various embodiments of the disclosure, when a moving image file is created using video data captured by an electronic device and audio data recorded by an external electronic device, the video data and the audio data may be synchronized in the created moving image file.

### Solution to Problem

An electronic device according to an embodiment of the disclosure may include a camera, a microphone, a wireless communication circuit transmitting and receiving data with respect to an external electronic device, and at least one processor operatively coupled to the camera, the microphone, and the wireless communication circuit. The at least one processor may obtain first video data by using the camera, obtain first reference data depending on a first schedule during a first time duration by using a microphone, receive first audio data corresponding to the first video data from the external electronic device via the wireless communication circuit, change the first schedule to a second schedule, based on a comparison result between the first reference data and a portion of the first audio data, obtain second reference data depending on the second schedule during a second time duration subsequent to the first time duration by using the microphone, correct a delay of the first audio data, based on the second reference data, and create a moving image file, based on the first video data and the corrected first audio data.

A method of operating an electronic device according to an embodiment of the disclosure may include obtaining first video data by using a camera included in the electronic device, obtaining first reference data depending on a first schedule during a first time duration by using a microphone included in the electronic device, receiving first audio data corresponding to the first video data from an external electronic device via a wireless communication circuit included in the electronic device, changing the first schedule to a second schedule, based on a comparison result between the first reference data and a portion of the first audio data, obtaining second reference data depending on the second schedule during a second time duration subsequent to the first time duration by using the microphone, correcting a delay of the first audio data, based on the second reference data, and creating a moving image file, based on the first video data and the corrected first audio data.

An electronic device according to an embodiment of the disclosure may include a camera, a microphone, a wireless communication circuit transmitting and receiving data with respect to an external electronic device including a first external microphone and a second external microphone, and at least one processor operatively coupled to the camera, the microphone, and the wireless communication circuit. The at least one processor may obtain first video data by using the camera, obtain first reference data depending on a first schedule during a first time duration by using a microphone, receive, via the wireless communication circuit, the first audio data obtained by the external electronic device by using the first external microphone and second audio data obtained by the external electronic device by using the second external microphone, wherein the first audio data and the second audio data correspond to the first video data, and analyze a correlation between the second reference data and each of the first audio data and the second audio data, change the first schedule to a second schedule, based on at least one of a comparison result between the first reference data and a portion of the first audio data and a comparison result between the first reference data and a portion of the second audio data, obtain second reference data depending on the second schedule during a second time duration subsequent to the first time duration by using the microphone, select any one of audio data satisfying a specified condition from the first audio data and the second audio data, based on a comparison result between the second reference data and each of the first audio data and the second audio data, correct a delay of the selected audio data, based on the second reference data, and create a moving image file, based on the first video data and the corrected audio data.

### Advantageous Effects of Invention

According to various embodiments of the disclosure, when creating a moving image file by using video data captured by an electronic device and audio data recorded by an external electronic device, the electronic device may obtain the moving image file based on video data and audio data temporally synchronized with each other.

In addition, according to various embodiments of the disclosure, an electronic device may obtain a moving image file including stereo audio data by using audio data obtained from a pair of Bluetooth earphones. A user may feel a sense of presence or liveliness through the moving image file including the stereo audio data.

In addition, according to various embodiments of the disclosure, when synchronizing video data and audio data, an electronic device may correct a delay of the audio data adaptively to a surrounding environment.

In addition thereto, advantages acquired in the disclosure are not limited to the aforementioned advantages, and other advantages not mentioned herein may be clearly understood by those skilled in the art to which the disclosure pertains from the following descriptions.

### BRIEF DESCRIPTION OF DRAWINGS

FIG. 1 is a block diagram of an electronic device in a network environment according to various embodiments;

FIG. 2 is a block diagram illustrating a camera module according to various embodiments;

FIG. 3 is a block diagram illustrating a structure in which an electronic device creates a moving image file according to an embodiment;

FIG. 4 illustrates an example of an external electronic device according to an embodiment;

FIG. 5 is a block diagram illustrating a structure of an external electronic device according to an embodiment;

FIG. 6 illustrates an example in which an electronic device obtains audio data from an external electronic device according to an embodiment;

FIG. 7A illustrates an example of correcting a delay of audio data obtained by an electronic device from an external electronic device according to an embodiment;

FIG. 7B is a flowchart illustrating an operation in which an electronic device creates a moving image file, based on first audio data obtained from an external electronic device according to an embodiment;

FIG. 8 illustrates an example in which an electronic device analyzes a correlation between reference data and audio data according to an embodiment;

FIG. 9A illustrates an example in which an electronic device changes a schedule for obtaining reference data according to an embodiment;

FIG. 9B illustrates an example in which an electronic device changes a first schedule to a second schedule, based on first reference data and a portion of first audio data according to an embodiment;

FIG. 9C is a flowchart illustrating an operation in which an electronic device creates a moving image file, based on first audio data obtained from an external electronic device according to an embodiment;

FIG. 10 illustrates an example in which an electronic device applies a noise filter to reference data and audio data according to an embodiment;

FIG. 11 illustrates an example of a case where an external electronic device includes a plurality of external microphones according to an embodiment;

FIG. 12A illustrate an example in which an electronic device creates a moving image file by selectively using audio data according to an embodiment; and

FIG. 12B illustrates an example of a User Interface (UI) displayed on a display by an electronic device according to an embodiment.

With regard to the description of the drawings, the same or similar reference numerals may be used to refer to the same or similar elements.

### MODE FOR CARRYING OUT THE INVENTION

Hereinafter, various embodiments of the present disclosure are disclosed with reference to the accompanying drawings. However, the present disclosure is not intended to be limited by the various embodiments of the present disclosure to a specific embodiment and it is intended that the present disclosure covers all modifications, equivalents, and/or alternatives of the present disclosure provided they come within the scope of the appended claims and their equivalents.

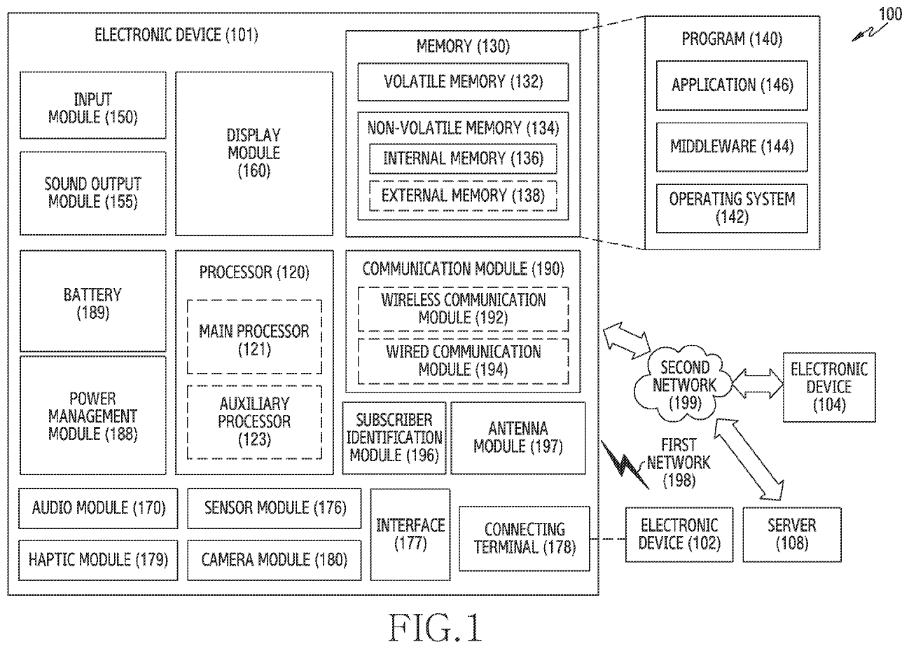

FIG. 1 is a block diagram of an electronic device in a network environment according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

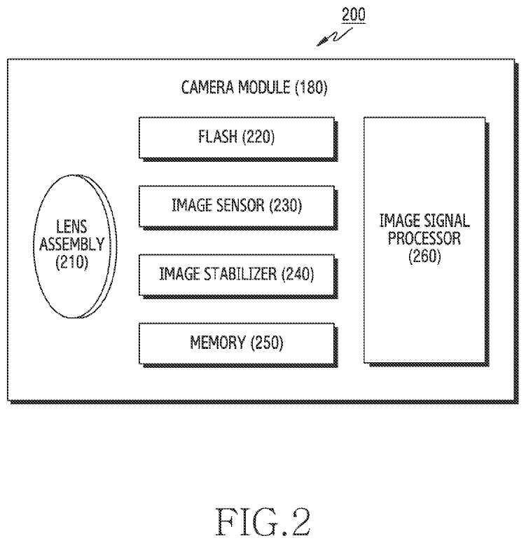

FIG. 2 is a block diagram illustrating a camera module according to various embodiments. Referring to FIG. 2, the camera module 180 may include a lens assembly 210, a flash 220, an image sensor 230, an image stabilizer 240, memory 250 (e.g., buffer memory), and/or an image signal processor 260. The lens assembly 210 may collect light emitted or reflected from an object whose image is to be taken. The lens assembly 210 may include one or more lenses. According to an embodiment, the camera module 180 may include a plurality of lens assemblies 210. In such a case, the camera module 180 may form, for example, a dual camera, a 360-degree camera, or a spherical camera. Some of the plurality of lens assemblies 210 may have the same lens attribute (e.g., view angle, focal length, auto-focusing, f number, or optical zoom), or at least one lens assembly may have one or more lens attributes different from those of another lens assembly. The lens assembly 210 may include, for example, a wide-angle lens or a telephoto lens.

The flash 220 may emit light that is used to reinforce light reflected from an object. According to an embodiment, the flash 220 may include one or more light emitting diodes (LEDs) (e.g., a red-green-blue (RGB) LED, a white LED, an infrared (IR) LED, or an ultraviolet (UV) LED) or a xenon lamp. The image sensor 230 may obtain an image corresponding to an object by converting light emitted or reflected from the object and transmitted via the lens assembly 210 into an electrical signal. According to an embodiment, the image sensor 230 may include one selected from image sensors having different attributes, such as a RGB sensor, a black-and-white (BW) sensor, an IR sensor, or a UV sensor, a plurality of image sensors having the same attribute, or a plurality of image sensors having different attributes. Each image sensor included in the image sensor 230 may be implemented using, for example, a charged coupled device (CCD) sensor or a complementary metal oxide semiconductor (CMOS) sensor.

The image stabilizer 240 may move the image sensor 230 or at least one lens included in the lens assembly 210 in a particular direction, or control an operational attribute (e.g., adjust the read-out timing) of the image sensor 230 in response to the movement of the camera module 180 or the electronic device 101 including the camera module 180. This allows compensating for at least part of a negative effect (e.g., image blurring) by the movement on an image being captured. According to an embodiment, the image stabilizer 240 may sense such a movement by the camera module 180 or the electronic device 101 using a gyro sensor (not shown) or an acceleration sensor (not shown) disposed inside or outside the camera module 180. According to an embodiment, the image stabilizer 240 may be implemented, for example, as an optical image stabilizer. The memory 250 may store, at least temporarily, at least part of an image obtained via the image sensor 230 for a subsequent image processing task. For example, if image capturing is delayed due to shutter lag or multiple images are quickly captured, a raw image obtained (e.g., a Bayer-patterned image, a high-resolution image) may be stored in the memory 250, and its corresponding copy image (e.g., a low-resolution image) may be previewed via the display device 160. Thereafter, if a specified condition is met (e.g., by a user's input or system command), at least part of the raw image stored in the memory 250 may be obtained and processed, for example, by the image signal processor 260. According to an embodiment, the memory 250 may be configured as at least part of the memory 130 or as a separate memory that is operated independently from the memory 130.

The image signal processor 260 may perform one or more image processing with respect to an image obtained via the image sensor 230 or an image stored in the memory 250. The one or more image processing may include, for example, depth map generation, three-dimensional (3D) modeling, panorama generation, feature point extraction, image synthesizing, or image compensation (e.g., noise reduction, resolution adjustment, brightness adjustment, blurring, sharpening, or softening). Additionally or alternatively, the image signal processor 260 may perform control (e.g., exposure time control or read-out timing control) with respect to at least one (e.g., the image sensor 230) of the components included in the camera module 180. An image processed by the image signal processor 260 may be stored back in the memory 250 for further processing, or may be provided to an external component (e.g., the memory 130, the display device 160, the electronic device 102, the electronic device 104, or the server 108) outside the camera module 180. According to an embodiment, the image signal processor 260 may be configured as at least part of the processor 120, or as a separate processor that is operated independently from the processor 120. If the image signal processor 260 is configured as a separate processor from the processor 120, at least one image processed by the image signal processor 260 may be displayed, by the processor 120, via the display device 160 as it is or after being further processed.

According to an embodiment, the electronic device 101 may include a plurality of camera modules 180 having different attributes or functions. In such a case, at least one of the plurality of camera modules 180 may form, for example, a wide-angle camera and at least another of the plurality of camera modules 180 may form a telephoto camera. Similarly, at least one of the plurality of camera modules 180 may form, for example, a front camera and at least another of the plurality of camera modules 180 may form a rear camera.

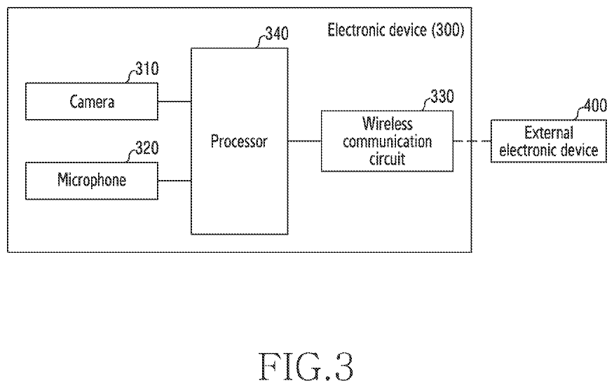

FIG. 3 is a block diagram illustrating a structure in which an electronic device 300 creates a moving image file according to an embodiment.

Referring to FIG. 3, the electronic device 300 may include a camera 310, a microphone 320, a wireless communication circuit 330, and a processor 340. The electronic device 300 of FIG. 3 may correspond to the electronic device 101 of FIG. 1. It may be understood that the camera 310 of FIG. 3 corresponds to or is included in the camera module 180 of FIG. 1 and FIG. 2. It may be understood that the microphone 320 of FIG. 3 is included in the input module 150 of FIG. 1. It may be understood that the wireless communication circuit 330 of FIG. 3 is included in the wireless communication module 192 of FIG. 1. The processor 340 of FIG. 3 may correspond to the processor 120 of FIG. 1.

According to an embodiment, the camera 310 may include the lens assembly 210 and the image sensor 230. The image sensor 230 may be a Complementary Metal Oxide Semiconductor (CMOS) sensor. A plurality of pixels may be integrated in the image sensor 230, and each separate pixel may include a micro lens, a color filter, and a PhotoDiode (PD). Each separate pixel may convert light, which is input to a light detector, into an electrical signal. For example, the image sensor 230 may amplify current produced by the light received via the lens assembly 210 by using a photoelectric effect of a light receiving element.

According to an embodiment, the camera 310 may obtain video data. The processor 340 may obtain the video data including a plurality of image frames by using the camera 310. The camera 310 may provide the processor 340 with the video data including the plurality of image frames. For example, the image sensor 230 may continuously obtain an image frame corresponding to the light received via the lens assembly 210 and provide the image frame to the processor 340 (or the image signal processor 260). According to an embodiment, the processor 340 may obtain first video data by using the camera 310.

According to an embodiment, the microphone 320 may obtain audio data. The processor 340 may obtain the audio data via the microphone 320. For example, the processor 340 may obtain the audio data produced from user's voice data and/or a surrounding environment via the microphone 320.

According to an embodiment, the microphone 320 may include a plurality of microphones. For example, the processor 340 may obtain an audio data set via the plurality of microphones.

According to an embodiment, the processor 340 may obtain reference data by using the microphone 320. It may be understood that the reference data is a reference signal which may be compared to audio data received from an external electronic device 400. In audio data which may be obtained by the microphone 320, data obtained to perform an embodiment of the disclosure may be referred to as the reference data.

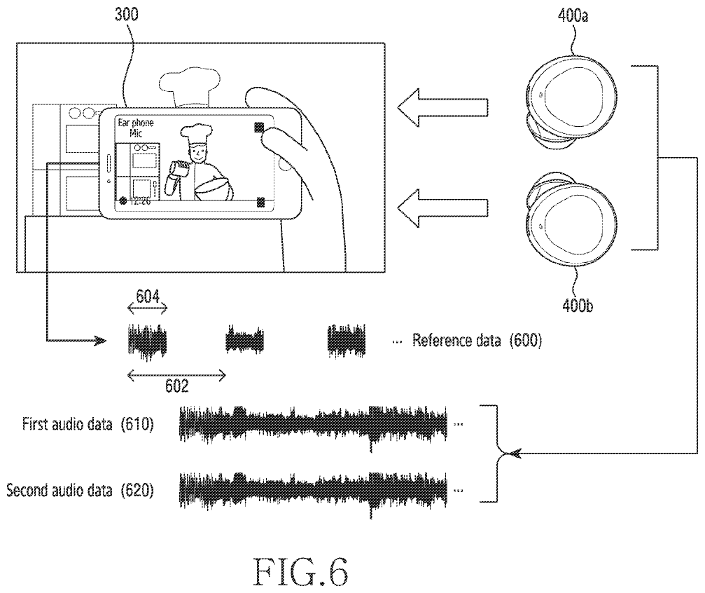

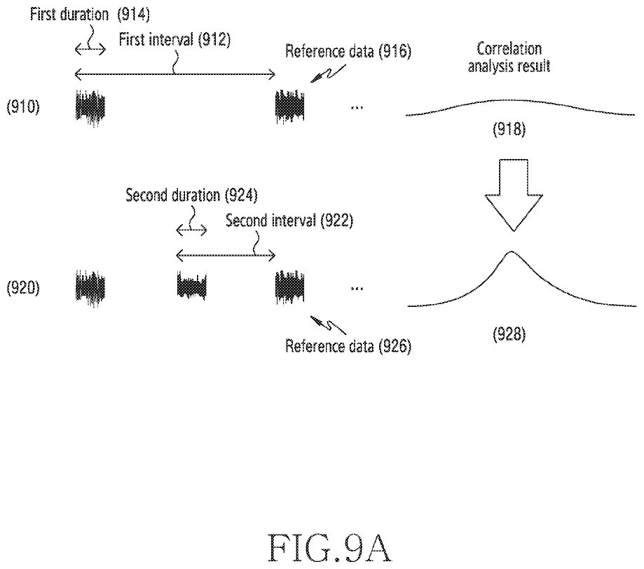

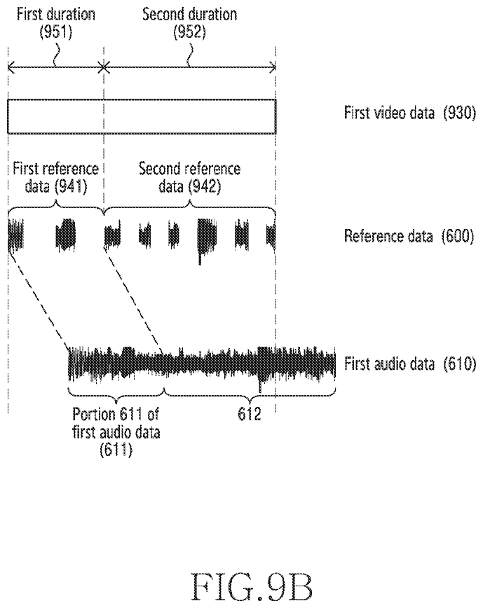

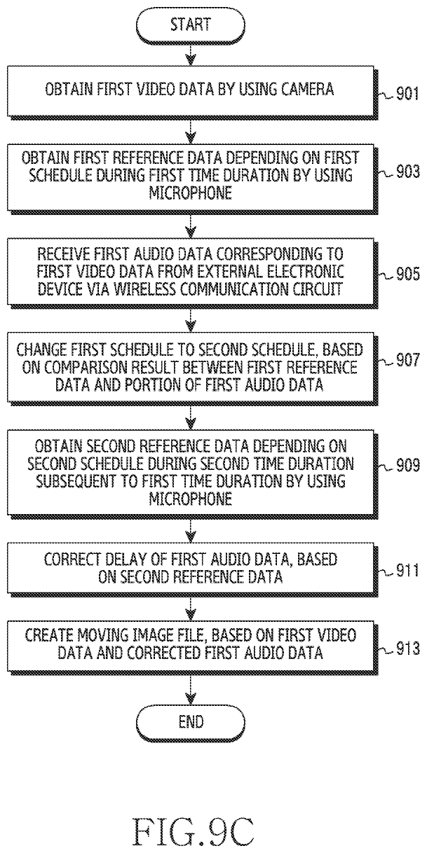

According to an embodiment, the processor 340 may obtain the reference data depending on a specified schedule during a specified time duration by using the microphone 320. For example, the processor 340 may obtain first reference data depending on a first schedule during a first time duration by using the microphone 320 and obtain second reference data depending on a second schedule during a second time duration subsequent to the first time duration. The reference data obtained depending on the specified schedule during the specific time duration will be described below with reference to FIG. 6 and FIG. 9A.

According to an embodiment, the wireless communication circuit 330 may transmit/receive data with respect to the external electronic device 400. The processor 340 may receive the data from the external electronic device 400 via the wireless communication circuit 330. For example, the processor 340 may receive first audio data recorded by the external electronic device 400 via the wireless communication circuit 330. The processor 340 may transmit data to the external electronic device 400 via the wireless communication circuit 330. For example, the processor 340 may transmit a signal which starts or stops recoding of the first audio data to the external electronic device 400 via the wireless communication circuit 330. As another example, the processor 340 may transmit audio to be output by the external electronic device 400 via the wireless communication circuit 330.

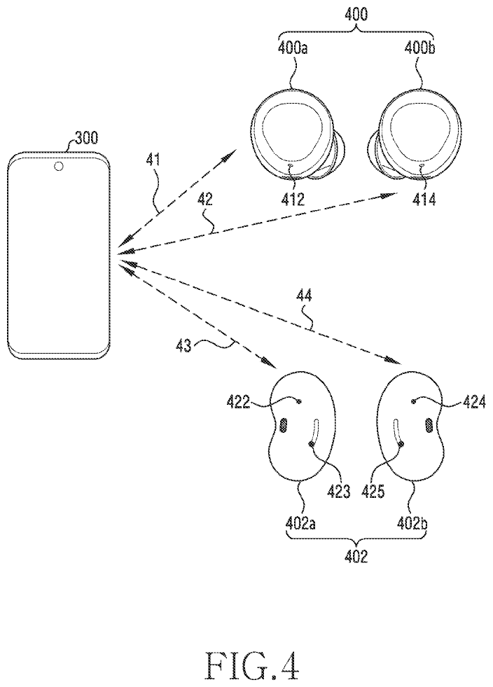

According to an embodiment, the wireless communication circuit 330 may transmit/receive data with respect to the external electronic device 400 via a wireless network. For example, the wireless communication circuit 330 may communicate with the external electronic device 400 through a short-range communication network (e.g., Bluetooth or WiFi). A communication scheme between the wireless communication circuit 330 and the external electronic device 400 will be described below with reference to FIG. 4.

According to an embodiment, it may be understood that the processor 340 is at least one processor. For example, it may be understood that the processor 340 is at least one of an Application Processor (AP) and a Communication Processor (CP). According to an embodiment, the processor 340 may create a moving image file, based on video data obtained via the camera 310, reference data obtained via the microphone 320, audio data obtained via the wireless communication circuit 330.

FIG. 4 illustrates an example of an external electronic device 400 according to an embodiment.

Referring to FIG. 4, the electronic device 300 may communicate with the external electronic device 400 via a wireless network. The processor 340 may transmit/receive data with respect to the external electronic device 400 via the wireless communication circuit 330.

The external electronic device 400 may include one or more audio output devices. According to an embodiment, the external electronic device 400 may be configured as a pair so as to be worn on part of a user's body (e.g., both ears). For example, the external electronic device 400 may include a first ear bud 400a wearable on a user's left ear and a second ear bud 400b wearable on a user's right ear.

According to an embodiment, the external electronic device 400 may include an external microphone. In the disclosure, it may be understood that the external microphone means a microphone included in the external electronic device 400 and different from the microphone 320 included in the electronic device 300. For example, the first ear bud 400a may include a first external microphone 412, and the second ear bud 400b may include a second external microphone 414. The first ear bud 400a may obtain first audio data via the first external microphone 412, and the second ear bud 400b may obtain second audio data via the second external microphone 414. According to an embodiment, the first ear bud 400a may transmit the first audio data and the second audio data respectively to the first ear bud 400a and the second ear bud 400b via the wireless network. For example, the first ear bud 400a may transmit/receive data with respect to the electronic device 300 via a wireless data transmission/reception path 41, and the second ear bud 400b may transmit/receive data with respect to the electronic device 300 via a wireless data transmission/reception path 42. The external electronic device 400 may transmit audio data obtained via the external microphones 412 and 414 to the electronic device 300. The electronic device 300 may receive audio data (e.g., the first audio data, the second audio data) obtained by the external electronic device 400 via the wireless communication circuit 330. According to an embodiment, the external electronic device 400 may use the wireless data transmission/reception to transmit a response signal for data transmitted by the electronic device 300 to the external electronic device 400 or transmit data (e.g., a sensor value obtained via a sensor) created by the external electronic device 400 or transmit state information (e.g., a remaining battery level) of the external electronic device 400.

According to an embodiment, the external electronic device 400 may output audio in a state of being worn a user's body. According to an embodiment, the first ear bud 400a and the second ear bud 400b may use wireless data transmission/reception to receive audio from the electronic device 300, and may output the received audio. For example, each of the first ear bud 400a and the second ear bud 400b may include a speaker, and may output audio received from the electronic device 300 via the speaker.

According to an embodiment, the wireless data transmission/reception paths 41 and 42 may include at least one of a path for a Bluetooth communication scheme, a path for a Bluetooth Low Energy (BLE) communication scheme, a path for a Wireless Fidelity (Wi-Fi) direct communication scheme, and a path for a mobile communication scheme (e.g., cellular communication, sidelink). For example, in case of using the Bluetooth communication scheme or the BLE communication scheme, the external electronic device 400 and the electronic device 300 may identify wireless communication addresses of each other and may perform communication.

According to an embodiment, the external electronic device 400 may transmit/receive data with respect to the electronic device 300 by using a TWS+ or Audio over BLE (AoBLE) scheme. When the external electronic device 400 uses the TWS+ or AoBLE scheme, each of the first ear bud 400a and the second ear bud 400b may transfer information by connecting communication with the electronic device 300. In another embodiment, the external electronic device 400 may transmit/receive data with respect to the electronic device 300 in a sniffing manner, or may transmit/receive data in a relay manner. For example, the first ear bud 400a may receive data from the second ear bud 400b and transmit the data to the electronic device 300 together with the data obtained by the first ear bud 400a. As another example, the first ear bud 400a may transmit to the electronic device 300 the data received from the second ear bud 400b and the data obtained by the first ear bud 400a by dividing a time duration. As another example, the first ear bud 400a may transmit to the electronic device 300 the data received from the second ear bud 400b. In addition thereto, various communication schemes implementable by ordinarily skilled in the art may be used for transmitting/receiving data between the electronic device 300 and the external electronic device 400.

According to an embodiment, in the description related to FIG. 4, the description on the external electronic device 400 may also be applied to an external electronic device 402 except for the description on the number of external microphones. That is, the external electronic device 402 may include a first ear bud 402a and a second ear bud 402b, and the electronic device 300 may transmit/receive data by connecting communication with each of the first ear bud 402a and the second ear bud 402b. For example, the first ear bud 402a may transmit/receive data with respect to the electronic device 300 via a wireless data transmission/reception path 43, and the second ear bud 402b may transmit/receive data with respect to the electronic device 300 through a wireless data transmission/reception path 44. The description on the wireless data transmission/reception paths 41 and 42 may also be applied to the wireless data transmission/reception paths 43 and 44.

According to an embodiment, the external electronic device 402 may include two or more external microphones. For example, the first ear bud 402a may include a first external microphone 422 and a second external microphone 423, and the second ear bud 402b may include a third external microphone 424 and a fourth external microphone 425. The first ear bud 402a may transmit to the electronic device 300 the first audio data obtained via the first external microphone 422 and the second audio data obtained via the second external microphone 423. The second ear bud 402b may transmit to the electronic device 300 third audio data obtained via the third external microphone 424 and fourth audio data obtained via the fourth external microphone 425. The electronic device 300 may receive the first audio data and the second audio data from the first ear bud 402a, and may receive the third audio data and the fourth audio data from the second ear bud 402b. For example, the first ear bud 402a may transmit each of the first audio data and the second audio data to the electronic device 300 by dividing a time duration (e.g., by using a retransmission section). In another embodiment, the first ear bud 402a may transmit to the electronic device 300 audio data satisfying a specified condition (e.g., audio data having better audio quality) between the first audio data obtained via the first external microphone 422 and the second audio data obtained via the second external microphone 423. In another embodiment, the first ear bud 402a may combine and transmit the first audio data and the second audio data to the electronic device 300.

FIG. 4 is not for restricting types of the external electronic devices 400 and 402, and embodiments of the disclosure may be applied to various types of the external electronic devices 400 and 402 including the external electronic device 412, 414, 422, 423, 424, or 425 and capable of communicating with the electronic device 300 via a wireless network. In addition, although embodiments are described hereinafter based on the external electronic device 400, embodiments applicable to the external electronic device 400 may be applied to the external electronic device 402.

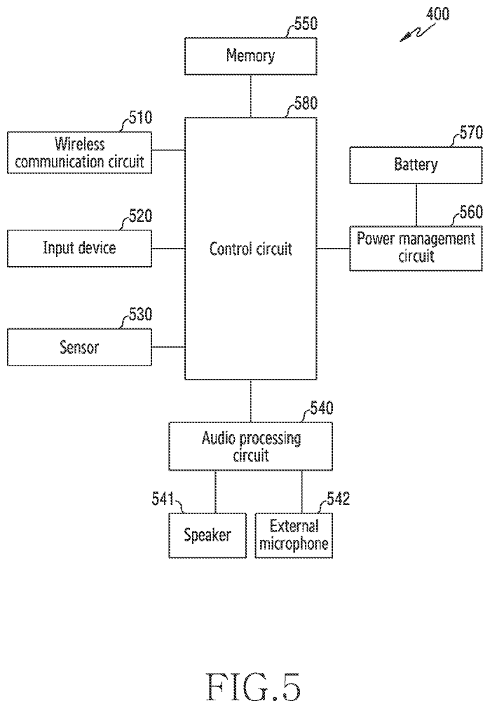

FIG. 5 is a block diagram illustrating a structure of the external electronic device 400 according to an embodiment.

Referring to FIG. 5, the external electronic device 400 (e.g., the first ear bud 400a, the second ear bud 400b) may include a plurality of electronic components disposed to an inner space. According to an embodiment, the external electronic device 400 may include a wireless communication circuit 510, an input device 520, a sensor 530, an audio processing circuit 540, a speaker 541, an external microphone 542, a memory 550, a power management circuit 560, a battery 570, and a control circuit 580. However, without being limited thereto, at least one of the electronic components may be omitted, or other electronic components may be further included. According to various embodiments of the disclosure, the external electronic device 400 may mean each of the first ear bud 400a and the second ear bud 400b.

According to an embodiment, the wireless communication circuit 510 may support various types of communication by using an antenna (not shown). According to an embodiment, the wireless communication circuit 510 may support reception of audio from the electronic device 300 (e.g., a server, a smartphone, a PC, a PDA, or an access point). According to an embodiment, the wireless communication circuit 510 may support transmission of audio data (e.g., the first audio data) to the electronic device 300.

According to an embodiment, the input device 520 may be configured to create various input signals required to operate the external electronic device 400. The input device 520 may include a touch pad, a touch panel, and/or a button. For example, the touch pad may recognize a touch input by using at least one of an electrostatic type, a pressure-sensitive type, an infrared type, and an ultrasonic type. For example, the button may include a physical button and/or an optical button.

According to an embodiment, the input device 520 may create a user input for power-on/off of the external electronic device 400. According to an embodiment, the input device 520 may create a user input for a communication (e.g., short-range communication) connection with the external electronic device 400 and the electronic device 300.

According to an embodiment, the input device 520 may create a user input associated with an output of audio (or audio content). For example, the user input may be associated with a function such as starting a playback of audio, pausing the playback, stopping the playback, controlling a playback speed, controlling a playback volume, or muting.

According to an embodiment, the sensor 530 may measure physical data associated with the external electronic device 400 or may detect an operating state of the external electronic device 400. In addition, the sensor 530 may convert measured or detected information into an electric signal. According to an embodiment, the sensor 530 may include at least one of a proximity sensor, an acceleration sensor, a gyro sensor, a magnetic sensor, a gesture sensor, a grip sensor, and a biometric sensor. According to an embodiment, the sensor 530 may detect a signal or information regarding whether the external electronic device 400 is in a state of being worn on a user's body.

According to an embodiment, the audio processing circuit 540 may include an audio decoder and a D/A converter. The audio decoder may convert audio data received from the electronic device 300 and stored in the memory 550 into a digital audio signal, and the D/A converter may convert the digital audio signal converted by the audio decoder into an analog audio signal. The speaker 541 may output the analog audio signal converted by the D/A converter.

According to an embodiment, the audio processing circuit 540 may include an A/D converter and an audio encoder. The A/D converter may convert the analog audio signal obtained via the external microphone 542 into a digital audio signal, and the audio encoder may convert the digital audio signal into audio data (e.g., first audio data).

According to an embodiment, the audio processing circuit 540 may be designed to be included in the control circuit 580.

According to an embodiment, the memory 550 may store various operating systems required to operate the external electronic device 400 and data or application programs and algorithms corresponding to various user functions. The memory 550 may include a fast random access memory and/or a non-volatile memory such as one or more magnetic disc storage devices, one or more optical storage devices, and/or a flash memory (e.g., NAND, NOR).

According to an embodiment, the memory 550 may include a non-volatile memory which stores non-volatile audio data received from the electronic device 300. According to an embodiment, the memory 550 may include a volatile memory which stores volatile audio data received from the electronic device 300.

According to an embodiment, the power management circuit 560 (e.g., a Power Management Integrated Circuit (PMIC)) may effectively manage and optimize a power usage of the battery 570 in the external electronic device 400. According to an embodiment, the control circuit 580 may transmit to the power management circuit 560 a corresponding signal depending on a load to be processed. The power management circuit 560 may regulate power to be supplied to the control circuit 580.

According to an embodiment, the power management circuit 560 may include a battery charging circuit. According to an embodiment, when the external electronic device 400 is coupled to a power supply device, the power management circuit 560 may be provided with power from the power supply device to charge the battery 570. According to an embodiment, the power management circuit 560 may support Power Line Communication (PLC) between the external electronic device 400 and the power supply device, and the external electronic device 400 may transmit and receive data with respect to the power supply device via the PLC.

According to an embodiment, the power management circuit 560 may include a wireless charging circuit. The wireless charging circuit may receive power wirelessly from the external device, and may charge the battery 570 by using the received power. According to an embodiment, the wireless charging circuit may support in-band communication between the external electronic device 400 and the power supply device. For example, when using the in-band communication, the external electronic device 400 and the power supply device may communicate via the wireless charging circuit by using the same frequency or an adjacent frequency to transfer the power. In this case, the wireless charging circuit may transmit/receive data between the external electronic device 400 and the power supply device by using a Frequency Shift Keying (FSK) modulation scheme or an Amplitude Shift Keying (ASK) modulation scheme.

According to an embodiment, the control circuit 580 may be configured to collect a variety of data to compute a desired output value. According to an embodiment, the control circuit 580 may support various operations, based on at least part of a user input from the input module device 520.

According to an embodiment, the control circuit 580 may be designed to receive audio data from the electronic device 300 via the wireless communication circuit 510 and store the received audio data into the memory 550. According to an embodiment, the control circuit 580 may receive non-volatile audio data (or download audio data) from the electronic device 300, and may store the received non-volatile audio data in the non-volatile memory. According to an embodiment, the control circuit 580 may receive volatile audio data (or streaming audio data) from the external device, and may store the received volatile audio data in the volatile memory.

According to an embodiment, the control circuit 580 may provide control to reproduce audio data (e.g., non-volatile audio data or volatile audio data audio data) stored in the memory 550 and output the audio data via the speaker 541. The control circuit 580 may decode the audio data to obtain an audio signal, and may provide control to output the obtained audio signal via the speaker 541.

According to an embodiment, the control circuit 580 may perform various operations, based on at least part of information obtained from the sensor 530. For example, the control circuit 580 may determine whether the external electronic device 400 is in a state of being worn on a user's body from the information obtained from the sensor 530.

According to an embodiment, the control circuit 580 may control the audio processing circuit 540 to reproduce audio data related to a corresponding sound effect or notification sound, in response to an alarm output request signal received from the power supply device and/or the electronic device 300.

According to an embodiment, the control circuit 580 may obtain a signal for starting or stopping recording of audio data (e.g., first audio data) via the wireless communication circuit 510. Upon receiving the signal for starting recording of the audio data via the wireless communication circuit 510, the control circuit 580 may control the audio processing circuit 540 to record the first audio data by enabling the external microphone 542. Upon receiving the signal for stopping recording of the audio data via the wireless communication circuit 510, the control circuit 580 may control the audio processing circuit 540 to stop recording of the first audio data by disabling the external microphone 542. According to an embodiment, while the first audio data is obtained or after the obtaining of the first audio data ends, the control circuit 580 may transmit the first audio data to the electronic device 300 via the wireless communication circuit 510.

According to an embodiment, the external electronic device 400 may further include various components depending on a provided type thereof. In addition, the external electronic device 400 may exclude specific components among the aforementioned components depending on the provided type thereof or may be replaced with another component.

FIG. 6 illustrates an example in which the electronic device 300 obtains audio data, e.g., first audio data 610 and second audio data 620, from the external electronic device 400 according to an embodiment.

Referring to FIG. 6, the electronic device 300 may perform video capturing by using the camera 310. The processor 340 may obtain first video data by using the camera 310. In addition, the external electronic device 400 (e.g., the first ear bud 400a, the second ear bud 400b) may obtain audio data corresponding to the first video data while the first video data is obtained. For example, the first ear bud 400a may obtain the first audio data 610 corresponding to the first video data, and the second ear bud 400b may obtain the second audio data 620 corresponding to the first video data. The processor 340 may receive audio data (e.g., the first audio data 610, the second audio data 620) corresponding to the first video data from the external electronic device 400 via the wireless communication circuit 330. For example, the processor 340 may obtain the first audio data 610 from the first ear bud 400a, and may obtain the second audio data 620 from the second ear bud 400b. As another example, the first ear bud 400a may receive the second audio data 620 from the second ear bud 400b, and the processor 340 may receive the first audio data 610 and the second audio data 620 from the first ear bud 400a. In addition thereto, the processor 340 may obtain the first audio data 610 and the second audio data 620 via various data transmission/reception paths.

According to an embodiment, the processor 340 may receive delayed audio data (e.g., the first audio data 610, the second audio data 620) from the external electronic device 400. For example, while the wireless communication circuit 330 receives the audio data via the wireless data transmission/reception path, a delay or interference may occur since the first ear bud 400a and the second ear bud 400b use the same path, or a delay may occur due to retransmission caused by a data reception failure. Accordingly, the first audio data 610 (or the second audio data 620) received by the processor 340 may be in a state of not being synchronized with the first video data. For example, a time by which the first audio data 610 (or the second audio data 620) is delayed compared to the first video data corresponds to the delay occurring in the wireless data transmission/reception path, and thus may be greater than the delay occurring in a wired data transmission/reception path. As another example, the time by which the first audio data 610 (or the second audio data 620) is delayed compared to the first video data may be unpredictable for the processor 340.

According to an embodiment, the electronic device 300 may obtain reference data 600 corresponding to the first video data by using the microphone 320. For example, the reference data 600 may refer to audio data obtained depending on a specified schedule via the microphone 320. The electronic device 300 may obtain the reference data 600 via the microphone 320 in order to correct the delay of the audio data (e.g., the first audio data 610, the second audio data 620) obtained from the external electronic device 400. Since the processor 340 may obtain the reference data 600 via the wired data transmission/reception path by using the microphone 320 included in the electronic device 300, the reference data 600 may not be delayed compared to the first video data or may include a delay small enough to be ignored. The reference data 600 may be understood as a reference signal (e.g., a reference audio signal) for correcting the delay of the first audio data 610 and/or the second audio data 620.

According to an embodiment, the processor 340 may obtain the reference data 600 depending on the specified schedule by using the microphone 320. Referring to FIG. 6, in a waveform graph of FIG. 6, the processor 340 may enable the microphone 320 at a time point corresponding to a duration 604, and may disable the microphone 320 at a time point not corresponding to the duration 604. According to another embodiment, the processor 340 may enable the microphone 320 during at least part of a time duration in a time point at which the first video data is obtained, and may use a portion of data obtained via the microphone 320 as the reference data 600.

According to an embodiment, the specified schedule may include an interval 602 and duration 604 in which the processor 340 enables the microphone 320. For example, the processor 340 may obtain the reference data 600 by enabling the microphone 320 for the specified duration 604 every specified interval 602.

According to an embodiment, the reference data 600 may be data obtained via the microphone 320 during the specified duration 604 depending on the specified interval 602. According to another embodiment, the specified schedule may also include a specific interval and different durations. The specified schedule may include various window patterns including time windows disposed variously. In addition thereto, various types of schedules obvious to those ordinarily skilled in the art are possible.

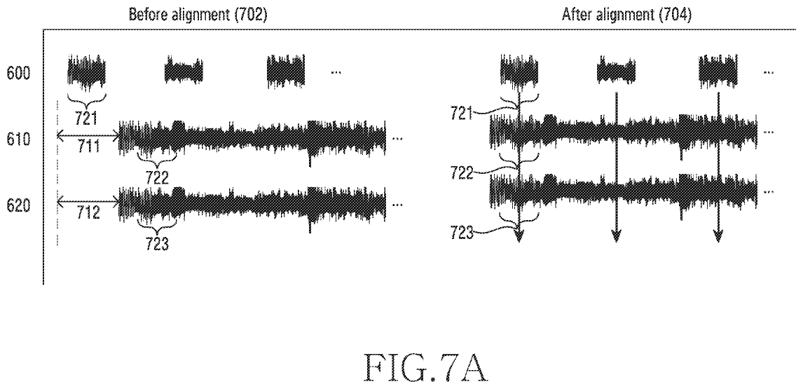

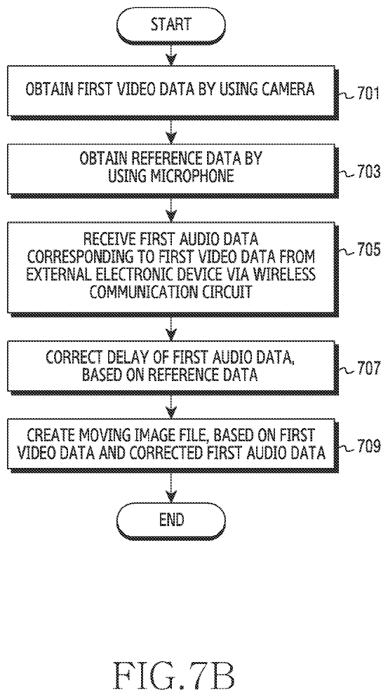

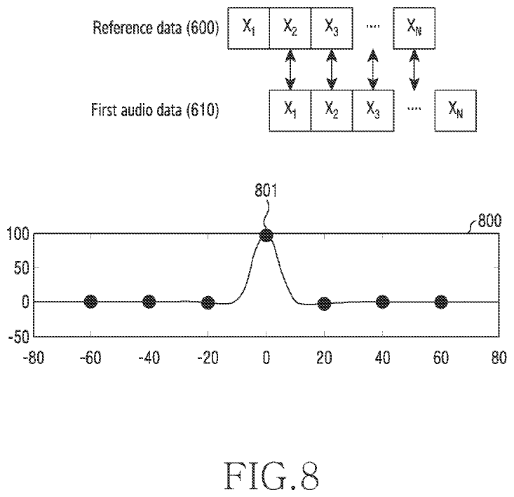

According to an embodiment, the processor 340 may correct the delay of the first audio data 610 and/or the second audio data 620, based on the reference data 600. The correction of the delay will be described with reference to FIG. 7A and FIG. 8.

According to an embodiment, the processor 340 may create a moving image file, based on the first video data and the first audio data 610 and/or the second audio data 620 of which the delay is corrected. The moving image file may include time-synchronized video data and audio data.

FIG. 7A illustrates an example of correcting a delay of the audio data 610 and 620 obtained by the electronic device 300 from the external electronic device 400 according to an embodiment.

Referring to a reference numeral 702 and content described with reference to FIG. 6, the first audio data 610 and second audio data 620 which are obtained by the electronic device 300 from the external electronic device 400 may be in a state of being delayed with respect to the reference data 600. Since the electronic device 300 obtains the first audio data 610 and the second audio data 620 from the external electronic device 400 via a wireless network, the processor 340 may obtain the first audio data 610 and/or the second audio data 620 that is not synchronized with the reference data 600.

According to an embodiment, the processor 340 may correct the delay of the first audio data 610 and/or second audio data 620, based on the reference data 600. For example, the processor 340 may analyze a correlation between the reference data 600 and the first audio data 610, may identify a time 711 by which the first audio data 610 is delayed with respect to the reference data 600, based on a correlation analysis result, and may correct the delay of the first audio data 610, based on the delayed time 711. For example, the processor 340 may consider that the first audio data 610 is obtained at a time earlier by the delayed time 711 than a time of receiving the first audio data 610, and may synchronize first video data and the first audio data 610. In addition, the processor 340 may analyze the correlation between the reference data 600 and the second audio data 620, may identify a time 712 by which the second audio data 620 is delayed with respect to the reference data 600, based on the correlation analysis result, and may correct the delay of the second audio data 620, based on the delayed time 712. For example, the processor 340 may consider that the second audio data 620 is obtained at a time earlier by the delayed time 712 than a time of receiving the second audio data 620, and may synchronize first video data 610 and the second audio data 620. A method of analyzing the reference data 600 and the first audio data 610 (or the second audio data 620) will be described below with reference to FIG. 8.

According to an embodiment, the processor 340 may correct the delay of the first audio data 610 and/or the second audio data 620 based on a similarity between the first audio data 610 (or the second audio data 620) and the reference data 600. For example, the processor 340 may determine that a similarity between a specific area 712 (e.g., a portion of the audio signal of the reference data 600) of the reference data 600 and a specific area 722 e.g., a portion of the audio signal of the second audio data 610) of the first audio data 610 is greater than or equal to a specified value. As another example, the processor 340 may compare a specific area (e.g., a portion of the audio signal) 721 of the reference data 600 and the audio data 610 and may determine that an area having the highest similarity of patterns (e.g., one or more signal patterns) is the specific area 722. The description on the specific area 722 of the first audio data 610 may also be applied to a specific area 723 of the second audio data 620.

Although it is illustrated in FIG. 7A that the delayed time 711 of the first audio data 610 is equal to the delayed time 712 of the second audio data 620, this is only an example, and thus the delayed time 711 and the delayed time 712 may be different from each other. For example, when the first ear bud 400a and the second ear bud 400b communicate independently with the wireless communication circuit 330 of the electronic device 300, the delayed time 711 and the delayed time 712 may be different from each other. The processor 340 may correct each of the delay of the first audio data 610 obtained from the first ear bud 400a and the delay of the second audio data 620 obtained from the second ear bud 400b.

Reference numeral 704 of FIG. 7A illustrates the first audio data 610 synchronized with the reference data 600 and the second audio data 620 synchronized with the reference data 600 following the time delay correction. For example, the processor 340 may obtain the first audio data 610 and/or second audio data 620 aligned with the reference data 600 through synchronization between the reference data 600 and the first audio data 610 and/or synchronization between the reference data 600 and the second audio data 620. Referring to FIG. 7A, the area 722 of the first audio data 610, having the highest similarity with the specific area 721 (e.g., signal portion) of the reference data 600, may be aligned with the specific area (signal portion) 721. In addition, the area 723 of the reference data 600, having the highest similarity with the specific area 721 (e.g., signal portion) of the second audio data 620, may be aligned with the specific area 721 (e.g., signal portion). The processor 340 may create a moving image file, based on the first audio data 610 and/or the second audio data 620, together with first video data.

Although an embodiment of a case where the electronic device 300 obtains the first audio data 610 from the first ear bud 400a and obtains the second audio data 620 from the second ear bud 400b has been described with reference to FIG. 6 and FIG. 7A, this is only an example, and thus various embodiments implementable by ordinarily skilled in the art are possible. For example, the external electronic device 400 may correspond to a single external device including an external microphone, may obtain the first audio data 610 from the external electronic device 400 which is the single external device, and may create a moving image file, based on the first audio data 610, together with the first video data.

According to various embodiments of the disclosure, when the electronic device 300 creates the first video data captured by the electronic device 300 and the moving image file by using the first audio data 610 recorded by the external electronic device 400, the electronic device 300 may obtain the moving image file based on the first video data and first audio data 610 temporally synchronized with each other.

In addition, according to various embodiments of the disclosure, the electronic device 300 may obtain a moving image file including stereo audio data by using audio data (e.g., the first audio data 610 and the second audio data 620) obtained from a pair of ear buds (e.g., the first ear bud 400a and the second ear bud 400b).

FIG. 7B is a flowchart illustrating an operation in which the electronic device 300 creates a moving image file, based on the first audio data 610 obtained from the external electronic device 400 according to an embodiment.

According to an embodiment, in operation 701, the processor 340 may obtain first video data by using the camera 310.

According to an embodiment, in operation 703, the processor 340 may obtain the reference data 600 by using the microphone 320.

According to an embodiment, in operation 705, the processor 230 may receive the first audio data 610 corresponding to the first video data from the external electronic device 400 via the wireless communication circuit 330.

According to an embodiment, in operation 707, the processor 340 may correct the delay of the first audio data 610, based on the reference data 600. The processor 340 may correct the delay of the first audio data 610 through the operation described with reference to FIG. 7A and/or an operation to be described with reference to FIG. 8.

According to an embodiment, in operation 709, the processor 340 may create a moving image file, based on the first video data and the corrected first audio data 610.

FIG. 8 illustrates an example in which the electronic device 300 analyzes a correlation between the reference data 600 and the audio data 610 and 620 according to an embodiment.

An example of a method of analyzing the correlation between the reference data 600 and the first audio data 610 is illustrated in FIG. 8. Although FIG. 8 is illustrated based on the first audio data 610, the correlation analysis method described with reference to FIG. 8 may also be applied to the second audio data 620, and in addition thereto, may also be applied to a variety of audio data obtained from the external electronic device 400.

According to an embodiment, the processor 340 may analyze the correlation between the reference data 600 and the first audio data 610 through a pattern matching scheme of the reference data 600 and first audio data 610. The processor 340 may synchronize the reference data 600 and the first audio data 610 through the pattern matching scheme. The processor 340 may identify an audio pattern included in the first audio data 610, and may synchronize the reference data 600 and the first audio data 610 by aligning the first audio data 610 with the reference data 600 so that the audio pattern matches the reference data 600.

According to an embodiment, the processor 340 may analyze an autocorrelation to identify the time 711 by which the first audio data 610 is delayed compared to the reference data 600. The processor 340 may analyze the autocorrelation by adding a Hadamard product (or an element-wise product) to the reference data 600 and the first audio data 610. The processor 340 may add the Hadamard product to data obtained by temporally shifting the first audio data 610. For example, the processor 340 may modify the first audio data 610 such that it is obtained earlier or later than a time at which the first audio data 610 is obtained, and may add the Hadamard product to the modified first audio data 610 together with the reference data 600.

According to an embodiment, the processor 340 may obtain a graph 800 corresponding to a correlation analysis result, by adding a Hadamard product to the reference data 600 and the first audio data 610 temporally moved. A horizontal axis of the graph 800 may represent a level by which the first audio data 610 is temporally moved, and a vertical axis of the graph 800 may represent a level by which the temporally moved first audio data 610 corresponds to the reference data 600. A peak 801 of the graph 800 may mean that the reference data 600 corresponds to the temporally moved first audio data 610. In case of the Hadamard product, since it has a maximum value when multiplied and added to the same or corresponding element, the peak 801 of the graph 800 may mean that the reference data 600 and the first audio data 601 are synchronized. For example, the processor 340 may obtain the first audio data 610 delayed by a first time compared to the reference data 600. The processor 340 may perform an autocorrelation analysis which adds the Hadamard product to the reference data 600 and data temporally moved from the first audio data 610. The processor 340 may determine that the first audio data 610 temporally moved forward by the first time corresponds to the peak 801 on the graph 800, based on the correlation analysis result. The processor 340 may determine that the delayed time 711 is the first time, based on the graph 800.

According to an embodiment, in order to analyze the correlation between the reference data 600 and the first audio data 610, the processor 340 may analyze the correlation while moving the first audio data 610 to an earlier time point and a later time point temporally as described with reference to FIG. 8. However, according to another embodiment, the processor 340 may not analyze the correlation while moving the first audio data 610 to a later time point temporally. Since the processor 340 receives the first audio data 610 through wireless communication, the first audio data 610 may not be obtained at an earlier time point than the reference data 600. Accordingly, the processor 340 may perform an operation of adding the Hadamard product while moving the first audio data 610 to the earlier time point rather than moving it to the later time point temporally.

According to an embodiment, the processor 340 may perform the delay correction operation described with reference to FIG. 7A and FIG. 8 for all packets (e.g., X₁, X₂, X₃ . . . X_{N}) of the first audio data 610, or may perform the delay correction operation at regular intervals. For example, the processor 340 may receive the first audio data 610 from the external electronic device 400 in unit of packets, and may correct the delay of the first audio data 610 by calculating a delayed time of the first audio data 610, based on the reference data 600 at regular intervals.

FIG. 9A illustrates an example in which the electronic device 300 changes a schedule for obtaining the reference data 600 according to an embodiment.

Referring to FIG. 9A, reference data 916 and reference data 926 may correspond to the reference data 600 described with reference to FIG. 6 to FIG. 8, except for the description on the schedule. In addition, graphs 918 and 928 corresponding to a correlation analysis result may be included in the graph 800 described with reference to FIG. 8.

Referring to reference numeral 910, the processor 340 may use the microphone 320 to obtain the reference data 916 according to a first schedule. The first schedule may include a first interval 912 and first duration 914 in which the processor 340 enables the microphone 320. The processor 340 may obtain the reference data 916 during the first duration 914 every first interval 912.

According to an embodiment, the processor 340 may analyze a correlation between the reference data 916 and the first audio data 610, in order to correct a delay of the first audio data 610. According to an embodiment, when the reference data 916 does not include a sufficient amount of audio patterns, the correlation between the reference data 916 and the first audio data 610 may be detected to be below a specified level. For example, the graph 918 corresponding to a correlation analysis result between the reference data 916 and the first audio data 610 may be shown to have a gentler shape than the specified level. The graph 918 having the gentler shape than the specified level may be a graph determined to be difficult to identify a peak.

According to an embodiment, when the correlation between the reference data 916 and the first audio data 610 is detected to be below a specified level, the processor 340 may change the first schedule for enabling the microphone 320 to a second schedule. When the processor 340 corrects the delay of the first audio data 610, based on the reference data 916, without having to change a schedule even if the correlation between the reference data 916 and the first audio data 610 is detected to be below the specified level, the reference data 916 and the corrected first audio data 610 may not be synchronized. Therefore, the processor 340 may obtain data including a greater amount of audio patterns than the reference data 916, by changing the first schedule to the second schedule.

According to an embodiment, the second schedule may be a schedule in which at least one of an interval and a duration is changed compared to the first schedule. For example, the processor 340 may obtain the reference data 926 every second interval 922 shorter than the first interval 912. As another example, the processor 340 may obtain the reference data 926 during a second duration 924 longer than the first duration 914. Although it is illustrated in FIG. 9A that the second interval 922 and the second duration 924 are changed compared to the first schedule, this is only an example, and thus only any one of the interval and the duration may be changed.

Referring to a reference numeral 920, the processor 340 may change the first schedule to the second schedule while obtaining the reference data 926 according to the first schedule by using the microphone 320, and then may continuously obtain the reference data 926. The reference data 926 may include an audio pattern greater in amount than the reference data 916. A case where the reference data 926 includes the audio pattern greater in amount than the reference data 916 may include a case where data is greater in capacity or a case where information required to analyze the correlation is included greater in amount.

According to an embodiment, the processor 340 may analyze a correlation between the reference data 926 and the first audio data 610, in order to correct the delay of the first audio data 610. According to an embodiment, when the reference data 926 includes a sufficient amount of audio patterns, the correlation between the reference data 926 and the first audio data 610 may be detected to be above a specified level. For example, the graph 928 corresponding to a correlation analysis result between the reference data 926 and the first audio data 610 may be a graph in which a peak is identifiable.

According to an embodiment, the processor 340 may change the schedule to the second schedule of which an interval is decreased or a duration is increased compared to the first schedule as shown in FIG. 9A. However, according to another embodiment, the processor 340 may also change the schedule to the second schedule of which an interval is increased or a duration is decreased compared to the first schedule. For example, a computation process to be performed by the processor 340 to correct the delay of the first audio data 610 increases along with an increase in capacity of the reference data. When the computation process of the processor 340 increases, battery efficiency may decrease, and a time required to create a moving image file may increase. Therefore, when the processor 340 obtains the reference data every interval longer than the first interval 912 or when it is determined that the delay of the first audio data 610 is correctable if the reference data is obtained for a duration shorter than the first duration 914, the schedule may be changed to the second schedule of which the interval is increased or the duration is decreased compared to the first schedule. For example, the processor 340 may minimize a time to enable the microphone 320, unless it is difficult to correct the delay of the first audio data 610.

According to various embodiments of the disclosure, when the first video data and the first audio data 610 are synchronized based on the reference data 600, 916, or 926, the electronic device 300 may correct the delay of the first audio data 610 adaptively to a surrounding environment.

FIG. 9B illustrates an example in which the electronic device 300 changes the first schedule to the second schedule, based on a portion 611 of the first audio data and first reference data 941 according to an embodiment. In FIG. 9B, first video data 930 may correspond to the video data described with reference to FIG. 6. The first reference data 941 and second reference data 942 may be included in the reference data 600 described with reference to FIG. 6. The portion 611 of the first audio data may be included in the first audio data 610 of FIG. 6.

According to an embodiment, the processor 340 may obtain the first video data 930 by using the camera 310, may obtain the first reference data 941 depending on the first schedule during a first time duration 951 by using the microphone 320, and may receive the first audio data 610 corresponding to the first video data 930 from the external electronic device 400 via the wireless communication circuit 330.

According to an embodiment, the processor 340 may change the first schedule to the second schedule, based on a comparison result between the portion 611 of the first audio data and the first reference data 941. For example, the processor 340 may detect a correlation between the first reference data 941 and the portion 611 of the first audio data. The processor 340 may determine that the correlation between the first reference data 941 and the portion 611 of the first audio data is detected to be below a specified level. According to an embodiment, the processor 340 may change the schedule to the second schedule different from the first schedule in that at least one of an interval and duration for enabling the microphone 320 is changed.

According to an embodiment, the processor 340 may obtain the second reference data 942 depending on the second schedule during a second time duration 952 subsequent to the first time duration 951 by using the microphone 320. For example, the processor 340 may obtain the second reference data 942 including a greater amount of information (e.g., an audio pattern) than the first reference data 941. According to an embodiment, the processor 340 may correct a delay of the first audio data 610, based on the second reference data 942. For example, the processor 340 may analyze a correlation between the second reference data 942 and the first audio data 610 (e.g., the reference numeral 612 in the first audio data), may identify a time by which the first audio data 610 (e.g., the reference numeral 612 of the first audio data 610) is delayed compared to the second reference data 942, based on a correlation analysis result (e.g., the graph 800, the graph 928), and may correct the delay of the first audio data 610, based on the delayed time.

With continued reference to FIG. 9B, although it is illustrated that the second time duration 952 is a time duration consecutive to the first time duration 951, this is only an example, and thus the second time duration 952 may include all time durations subsequent to the first time duration 951. For example, a regular time gap may be present between the first time duration 951 and the second time duration 952.

FIG. 9C is a flowchart illustrating an operation in which the electronic device 300 creates a moving image file, based on the first audio data 610 obtained from the external electronic device 400 according to an embodiment. The operation described with reference to FIG. 9C may be performed by the electronic device 300 or processor 340 of FIG. 3.

According to an embodiment, before operation 901, the processor 340 may receive from a user a user input to begin moving image capturing. The processor 340 may control the camera 310 to obtain first video data, in response to receiving of the user input. The processor 340 may transmit a signal for controlling the external electronic device 400 to obtain first audio data via the wireless communication circuit 330. The external electronic device 400 may control the external microphone 542 to obtain the first audio data in response to receiving of the signal for providing control to obtain the first audio data. In another embodiment, the processor 340 may transmit a signal for controlling the external electronic device 402 to obtain the first audio data and the second audio data via the wireless communication circuit 330 in response to receiving of the user input.

According to an embodiment, in operation 901, the processor 340 may obtain first video data by using the camera 310. The first video data may include a plurality of image frames.

According to an embodiment, in operation 903, the processor 340 may obtain first reference data depending on the first schedule during a first time duration by using the microphone 320.

According to an embodiment, in operation 905, the processor 230 may receive first audio data corresponding to the first video data from the external electronic device 400 via the wireless communication circuit 330. For example, the external electronic device 400 may include the first ear bud 400a and the second ear bud 400b, and the processor 340 may receive the first audio data from the first ear bud 400a and receive the second audio data from the second ear bud 400b. As another example, the external electronic device 402 (e.g., the first ear bud 402a) may include the first external microphone 422 and the second external microphone 423, and the processor 340 may receive the first audio data obtained by the external electronic device 402 by using the first external microphone 422 and the second audio data obtained by the external electronic device 402 by using the second external microphone 423.

According to an embodiment, in operation 907, the processor 340 may change the first schedule to the second schedule, based on a comparison result between the first reference data and a portion of the first audio data.

According to an embodiment, when the correlation between the first reference data and the first audio data is detected to be below a specified level as a result of analyzing the correlation between the portion of the first audio data and the first reference data, the processor 340 may change the first schedule to the second schedule. According to another embodiment, when the correlation between the first reference data and the first audio data is detected to be above the specified level as the result of analyzing the correlation between the portion of the first audio data and the first reference data, the processor 340 may correct the delay of the first audio data, based on the first reference data without having to change the schedule. For example, when a similar area is detected to be above the specified level as the result of analyzing the correlation between the first audio data and the first reference data, the processor 340 may correct the delay of the first audio data, based on the first reference data, and may create a moving image file, based on the corrected first audio data.

According to an embodiment, in operation 909, the processor 340 may obtain second reference data depending on the second schedule during a second time duration subsequent to the first time duration by using the microphone 320.

According to an embodiment, in operation 911, the processor 340 may correct a delay of the first audio data, based on the second reference data. According to an embodiment, when the processor 340 obtains the first audio data and the second audio data respectively from the first ear bud 400a and the second ear bud 400b or obtains the first audio data and the second audio data from the external electronic device 402, the processor 340 may correct the delay of each of the first audio data and second audio data, based on the second reference data.

According to an embodiment, in operation 913, the processor 340 may create a moving image file, based on the first video data and the corrected first audio data. For example, the processor 340 may perform video rendering by mixing the first video data and the corrected first audio data. For example, when the processor 340 obtains the first audio data and the second audio data respectively from the first ear bud 400a and the second ear bud 400b, the processor 340 may create a moving image file, based on the first video data, the corrected first audio data, and the corrected second audio data.

According to an embodiment, after operation 913, the processor 340 may receive a user input to stop moving image capturing from the user. The processor 340 may control the camera 310 to stop obtaining of the first video data, in response to receiving of the user input. The processor 340 may transmit a signal for controlling the external electronic device 400 to stop obtaining of the first audio data via the wireless communication circuit 330 and a signal for controlling the external electronic device 400 to provide the electronic device 300 with the first audio data. The external electronic device 400 may control the external microphone 542 to stop obtaining of the first audio data, in response to receiving of the signal for providing control to stop obtaining of the first audio data. In addition, the external electronic device 400 may transmit to the electronic device 300 via the wireless communication circuit 510 the first audio data obtained via the external microphone 542. In another embodiment, the processor 340 may transmit a signal for controlling the external electronic device 402 to stop obtaining of the first audio data and the second audio data via the wireless communication circuit 330 and a signal for controlling the external electronic device 402 to provide the electronic device 300 with the first audio data and the second audio data.

According to an embodiment, the external electronic device 400 may transmit the first audio data to the electronic device 300 via the wireless communication circuit 510 while obtaining the first audio data via the external microphone 542. According to another embodiment, the external electronic device 400 may store the first audio data in the memory 550 while obtaining the first audio data, and may transmit the first audio data to the electronic device 300 after stopping the obtaining of the first audio data.

According to an embodiment, through operations 901 to 913, the electronic device 300 may obtain a moving image file including first video data recorded by the electronic device 300 and first audio data (and/or second audio data) recorded by the external electronic device 400. The first audio data and the first video data may be in a mutually synchronized state. According to an embodiment, when the electronic device 300 receives the first audio data and second audio data obtained from the external electronic device 400 (e.g., the first ear bud 400a and the second ear bud 400b) through binaural recording and creates a moving image file containing the first video data, the first audio data, and the second audio data, the electronic device 300 may create a moving image file including stereo audio data (e.g., e.g., stereoscopic audio data). The user may feel a sense of presence or liveliness through a moving image file containing audio data acquired from the external electronic device 400.

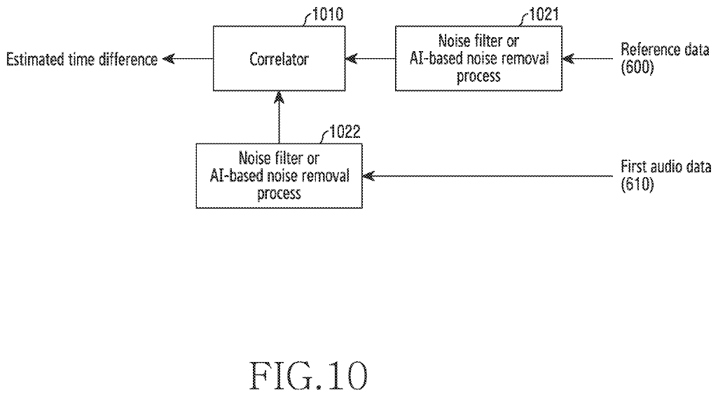

FIG. 10 illustrates an example in which the electronic device 300 applies noise filters 1021 and 1022 to the reference data 600 and audio data according to an embodiment.

Referring to FIG. 10, the processor 340 may analyze a correlation after applying a noise filter to the reference data 600 and the first audio data 610. It may be understood that the reference data 600 of FIG. 10 includes the reference data 916 and 926 of FIG. 9A and the first reference data 941 and second reference data 942 of FIG. 9B. The first audio data 610 of FIG. 10 may include a portion 611 of the first audio data of FIG. 9B, or may be replaced with the second audio data 620.

According to an embodiment, the processor 340 may analyze a correlation between the reference data 600 and the first audio data 610 to correct the delay of the first audio data 610, based on the reference data 600. For example, the processor 340 may include a correlator 1010. The correlator 1010 may be a hardware module disposed inside the processor 340, or may be a software module corresponding to a program executable by the processor 340. The processor 340 may analyze a correlation (e.g., autocorrelation) between the reference data 600 and the first audio data 610 via the correlator 1010.

According to an embodiment, the processor 340 may apply the first noise filter 1021 to the reference data 600 to generate filtered reference data, apply the second noise filter 1022 to the first audio data 610 to generate filtered audio data, and use the correlator 1010 to analyze a correlation between the reference data 600 to which the first noise filter 1021 is applied (e.g., the filtered reference data) and the first audio data 610 to which the second noise filter 1022 is applied (e.g., the filtered audio data). For example, when noise (e.g., wind sound) is included in at least one of the reference data 600 and the first audio data 610, it may be difficult to detect the correlation between the reference data 600 and the first audio data 610. When noise is included in any one of the reference data 600 and the first audio data 610 and the noise has a masking effect compared to an audio pattern commonly included in the reference data 600 and the first audio data 610, it may be difficult for the processor 340 to detect the correlation between the reference data 600 and the first audio data 610. Therefore, the processor 340 may analyze the correlation after applying the noise filters 1021 and 1022 respectively to the reference data 600 and the first audio data 610. According to an embodiment, the noise filters 1021 and 1022 may include an AI-based noise removal process and/or a Low Pass Filter (LPF). Since the noise which may be included in the reference data 600 and/or the first audio data 610 corresponds to high-frequency data in general, the processor 340 may filter the noise by using the LPF.

According to an embodiment, the processor 340 may identify a time by which the first audio data 610 is delayed compared to the reference data 600, based on a correlation analysis result between the reference data 600 to which the first noise filter 1021 is applied and the first audio data 610 to which the second noise filter 1022 is applied. For example, the processor 340 may estimate a time difference between the reference data 600 and the first audio data 610, based on an output result of the correlator 1010.

Referring to FIG. 9B and FIG. 10, the processor 340 may apply the first noise filter 1021 to the first reference data 941, and may apply the second noise filter 1022 to the first audio data 610. The processor 340 may analyze a correlation between the portion 611 of the first audio data to which the second noise filter 1022 is applied and the first reference data 941 to which the first noise filter 1021 is applied. For example, the processor 340 may analyze via the correlator 1010 the correlation between the portion 611 of the first audio data 610 to which the second noise filter 1022 is applied and the first reference data 941 to which the first noise filter 1021 is applied.

According to an embodiment, the processor 340 may determine whether the correlation analysis result between the portion 611 of the first audio data to which the second noise filter 1022 is applied and the first reference data 941 to which the first noise filter 1021 satisfies a specified condition. The specified condition may mean a case where it is determined that the delayed time of the first audio data 610 is identifiable based on the correlation analysis result. For example, when it is determined that a peak is identifiable in a graph corresponding to the correlation analysis result, the processor 340 may determine that the specified condition is satisfied.

According to an embodiment, the processor 340 may correct the delay of the first audio data 610, based on the first reference data 941 to which first noise filter 1021 is applied, in response that the correlation analysis result satisfies the specified condition. Upon determining that it is possible to correct the delay of the first audio data 610, based on the first reference data 941 to which the second noise filter 1022 is applied, the processor 340 may correct the delay of the first audio data 610 without having to change the first schedule for enabling the microphone 320 to the second schedule.

According to an embodiment, the processor 340 may change the first schedule to the second schedule, in response that the correlation analysis result does not satisfy the specified condition. Upon determining that it is difficult to correct the delay of the first audio data 610 even if the noise filters 1021 and 1022 are applied to the first reference data 941 and the portion 611 of the first audio data, the processor 340 may obtain the second reference data 942 by changing the schedule for enabling the microphone 320.

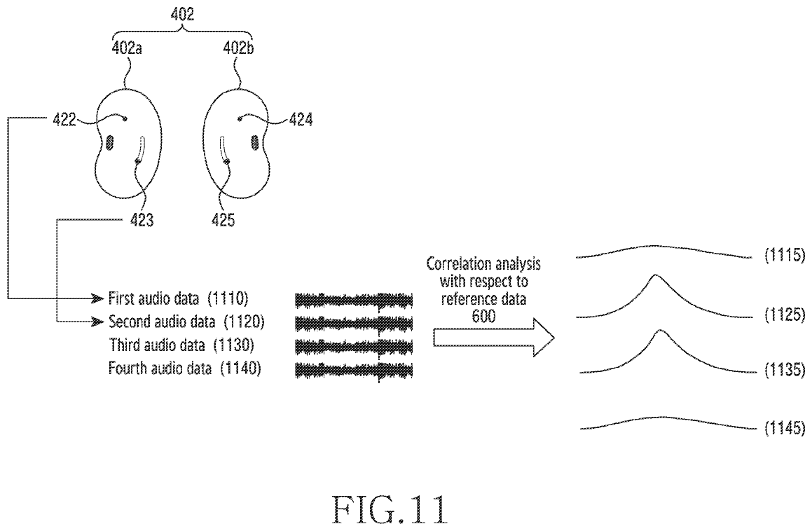

FIG. 11 illustrates an example of a case where the external electronic device 402 includes the plurality of external microphones 422, 423, 424, and 425 according to an embodiment.

Referring to FIG. 11, the external electronic device 400 of FIG. 5 to FIG. 10 may be replaced with the external electronic device 402, and the external electronic device 402 may include the first ear bud 402a and the second ear bud 402b. The first ear bud 402a may include the first external microphone 422 and the second external microphone 423, and the second ear bud 402b may include the third external microphone 424 and the fourth external microphone 425. However, in the explanation related to FIG. 11, the description on the first external microphone 422 and second external microphone 423 may be replaced with the description on the first external microphone 422 and second external microphone 423 included in the external electronic device 400.

According to an embodiment, the external electronic device 402 (e.g., the first ear bud 402a) may obtain first audio data 1110 corresponding to the first video data by using the first external microphone 422, and may obtain second audio data 1120 corresponding to the first video data by using the second external microphone 423. The external electronic device 402 (e.g., the first ear bud 402a) may transmit the first audio data 1110 and the second audio data 1120 to the electronic device 300 via a wireless data transmission/reception path. The processor 340 may receive the first audio data 1110 and the second audio data 1120 via the wireless communication circuit 330. The first audio data 1110 illustrated in FIG. 11 may be included in the first audio data 610 of FIG. 6. However, the second audio data 1120 illustrated in FIG. 11 is distinguished from the second audio data 620 of FIG. 6.

According to an embodiment, the processor 340 may analyze the correlation between the first audio data 1110 and the reference data 600, and may analyze the correlation between the second audio data 1110 and the reference data 600. That is, the processor 340 may analyze the correlation between the reference data 600 and each of the first audio data 1110 and the second audio data 1120.

Referring to FIG. 11, a graph 1115 may correspond to a correlation analysis result between the first audio data 1110 and the reference data 600, and a graph 1125 may correspond to a correlation analysis result between the second audio data 1120 and the reference data 600. According to an embodiment, the correlation analysis result between the first audio data 1110 and the reference data 600 and the correlation analysis result between the second audio data 1120 and the reference data 600 may be different from each other. For example, when the correlation between the first audio data 1110 and the reference data 600 is not fully detected, the graph 1115 may be shown to have a gentler shape than the graph 1125. That is, it may be easier to determine a peak in the graph 1125, compared to the graph 1115.

According to an embodiment, the processor 340 may select any one of audio data satisfying a specified condition from the first audio data 1110 and the second audio data 1120, based on the correlation analysis result (e.g., the graph 1115, the graph 1125). The specified condition may refer to audio data, which is more easily corrected by the processor 340, based on the reference data 600. For example, since it is easier to identify the peak in the graph 1125 than in the graph 1115, the processor 340 may determine that the second audio data 1120 satisfies the specified level out of the first audio data 1110 and the second audio data 1120.

According to an embodiment, the processor 340 may create a moving image file, based on first video data and the selected audio data (e.g., the second audio data 1120). For example, the processor 340 may create the moving image file, based on audio data which is best correlated with the reference data 600 among several sets of audio data obtained from the first ear bud 402a. Even when the several sets of audio data are received from the first ear bud 402a, the processor 340 may not generate the moving image file by using all pieces of received audio data.

According to an embodiment, the processor 340 may identify a time by which the selected audio data (e.g., the second audio data 1120) is delayed compared to the reference data 600, and may correct the delay of the first audio data 1110 and second audio data 1120, based on the delayed time. Since the first audio data 1110 and the second audio data 1120 are transmitted together through wireless communication between the electronic device 300 and the first ear bud 402a, a delayed time of audio data not selected may be corrected based on the delayed time of the selected audio data. For example, the processor 340 may identify the delayed time of the second audio data 1120, based on the correlation analysis result (e.g., the graph 1125) between the reference data 600 and the selected second audio data 1120. The processor 340 may correct the delay of not only the second audio data 1120 but also the first audio data 1110, based on the delayed time of the second audio data 1120. The processor 340 may create a moving image file, based on the corrected first audio data 1110 and the corrected second audio data 1120.

Referring to FIG. 9B and FIG. 11, the processor 340 may change the first schedule to the second schedule, based on a comparison result between the first reference data 921 and the first audio data 1110 (and/or the second audio data 1120), and may obtain the second reference data 942 according to the second schedule. The processor 340 may analyze a correlation between the first audio data 1110 and the second reference data 942, and may analyze a correlation between the second audio data 1120 and the second reference data 942. The graph 1115 may correspond to a correlation analysis result between the first audio data 1110 and the second reference data 942, and the graph 1125 may correspond to a correlation analysis result between the second audio data 1120 and the second reference data 942. Comparing the correlation analysis result (e.g., the graph 1115) between the first audio data 1110 and thee second reference data 942 and the correlation analysis result (e.g., the graph 1125) between the second audio data 1120 and the second reference data 942, since the second audio data 1120 is easier to detect the correlation with the second reference data 942, the processor 340 may create a moving image file, based on the second audio data 1120.

In the description related to FIG. 11, descriptions on the first audio data 1110 obtained via the first external microphone 422 and the second audio data 1120 obtained via the second external microphone 423 may also apply to third audio data 1130 obtained via the third external microphone 424 and fourth audio data 1140 obtained via the fourth external microphone 425. For example, the processor 340 may obtain the third audio data 1130 and the fourth audio data 1140 from the second ear bud 402b, may analyze a correlation between the reference data 600 and the third audio data 1130, and may analyze a correlation between the reference data 600 and the fourth audio data 1140. According to an embodiment, the processor 340 may determine that the third audio data 1130 satisfies the specified condition out of the third audio data 1130 and the fourth audio data 1140, and may create a moving image file, based on the first video data, the second audio data 1120, and the third audio data 1130. According to another embodiment, the processor 340 may determine that the third audio data 1130 satisfies the designated condition out of the third audio data 1130 and the fourth audio data 1140, may identify a time by which the third audio data 1130 is delayed compared to the reference data 600, and may correct the delay of the third audio data 1130 and fourth audio data 1150, based on the delayed time. The processor 340 may create a moving image file, based on the first video data, the first audio data 1110, the second audio data 1120, the third audio data 1130, and the fourth audio data 1140.

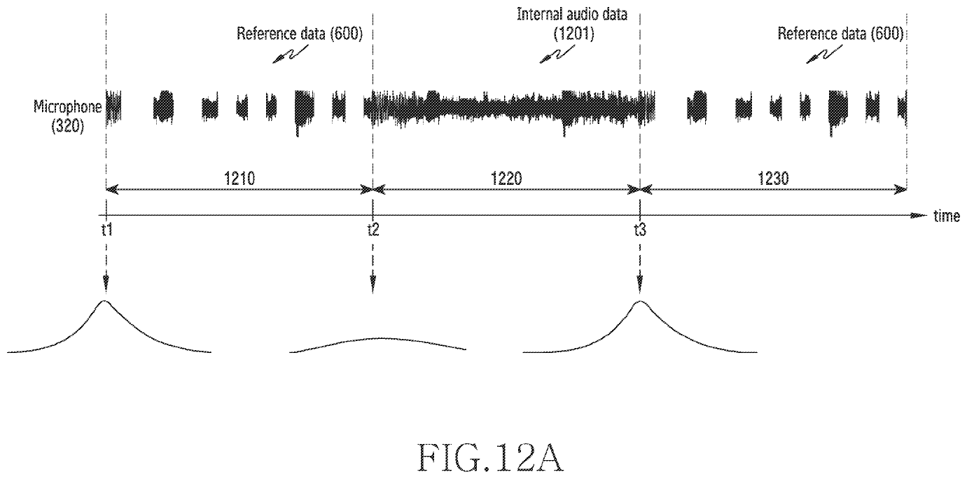

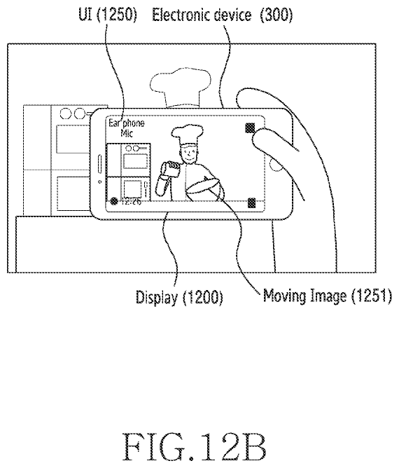

FIG. 12A illustrates an example in which the electronic device 300 creates a moving image file by selectively using audio data according to an embodiment.

According to an embodiment, the processor 340 may analyze the correlation between the reference data 600 obtained via the microphone 320 and the first audio data 610 obtained from the external electronic device 400, and may create a moving image file, based on any one of data out of the first audio data 610 and internal audio data 1201 obtained via the microphone 320 and the first video data 930, according to whether a correlation analysis result satisfies a specified condition. The specified condition may mean that the processor 340 is capable of correcting a delay of the first audio data 610, based on the reference data 600. That is, the processor 340 may determine whether the delay of the first audio data 610 is correctable based on the reference data 600, may generate a moving image file including the corrected first audio data when the delay is correctable, and may generate a moving image file including audio data obtained via the microphone 320 instead of the first audio data in a case where the delay is not correctable (e.g., in an environment where a lot of noise is recorded).

According to an embodiment, the processor 340 may correct the delay of the first audio data 610, based on the reference data 600, in response that the correlation analysis result satisfies the specified condition, and may create a moving image file, based on the first video data 930 and the first audio data 610 of which the delay is corrected.

According to an embodiment, the processor 340 may obtain the internal audio data 1201 corresponding to the first video data 930 by using the microphone 320, in response that the correlation analysis result does not satisfy the specified condition. The internal audio data 1201 may be understood as audio data continuously obtained by the processor 340 so as to correspond to the first video data 930 without having to disable the microphone 320. According to an embodiment, the processor 340 may create the moving image file, based on the first video data 930 and the internal audio data 1201. When the processor 340 obtains the internal audio data 1201 by using the microphone 320, since the internal audio data 1201 is provided to the processor 340 via a wired data transmission/reception path, the internal audio data 1201 may be data not delayed. Therefore, the processor 340 may create the moving image file, based on the first video data 930 obtained via the camera 310 and the internal audio data 1201 obtained via the microphone 320, without having to correct the delay of the internal audio data 1201.

FIG. 12A illustrates an example of creating a moving image file, based on the first audio data 610 or the internal audio data 1201 according to a time flow. A horizontal axis of a graph illustrated in FIG. 12A represents a time progress.

According to an embodiment, at a time point t1, the processor 340 may analyze a correlation between the reference data 600 and the first audio data 610. Referring to FIG. 12A, the processor 340 may determine that the correlation analysis result at the time point t1 satisfies the specified condition. According to an embodiment, the processor 340 may create a moving image file corresponding to a first section 1210, based on the first video data 930 and the first audio data 610 which is obtained from the external electronic device 400 and of which a delay is corrected.

According to an embodiment, at a time point t2, the processor 340 may determine that the correlation analysis result between the reference data 600 and the first audio data 610 does not satisfy the specified condition. For example, the processor 340 may continuously analyze the correlation between the reference data 600 and the first audio data 610 during the first section 1210, and may determine that the correlation analysis result does not satisfy the specified condition at the time point t2. According to an embodiment, the processor 340 may continuously enable the microphone 320 during a second section 1220 to obtain the internal audio data 1201. The processor 340 may create a moving image file corresponding to the second section 1220, based on the first video data 930 and the internal audio data 1201 obtained via the microphone 320.

According to an embodiment, at a time point t3, the processor 340 may determine that the correlation analysis result between the reference data 600 and the first audio data 610 satisfies the specified condition. For example, the processor 340 may obtain the first audio data 610 from the external electronic device 400 even during the second section 1220, and may obtain the reference data 600, based on a portion of the internal audio data 1201. The processor 340 may continuously analyze the correlation between the reference data 600 and the first audio data 610, and may determine that the correlation analysis result satisfies the specified condition at the time point t3. According to an embodiment, the processor 340 may change a schedule of enabling the microphone 320 during the third section 1230 similarly to the first section 1210, and may create a moving image file corresponding to the third section 1230, based on the first video data 930 and the corrected first audio data 610.

Although the processor 340 is described based on the correlation analysis between the reference data 600 and the first audio data 610 in relation to FIG. 12A, this is only an example, and various embodiments are possible. For example, the processor 340 may analyze the correlation between the first audio data 610 and the second reference data 942 of the reference data 600, described with reference to FIG. 9A. As another example, the processor 340 may analyze the correlation between the reference data 600 and audio data (e.g., the second audio data 620 of FIG. 6) obtained from the second ear bud 402b.

According to an embodiment, as shown in FIG. 12A, the processor 340 may obtain the reference data 600 by cyclically enabling the microphone 320 in the first section 1210, and may obtain the internal audio data 1210 by persistently enabling the microphone 320 in the second section 1220. However, unlike in FIG. 12A, the processor 340 may obtain data by persistently enabling the microphone 320 even in the first section 1210, and may use a portion of data obtained during the first section 1210 as the reference data 600.

FIG. 12B illustrates an example of a UI 1250 displayed on a display (e.g., the display module 160 of FIG. 1) by the electronic device 300 according to an embodiment. The electronic device 300 of FIG. 12B may correspond to the electronic device 101 of FIG. 1, and the electronic device 300 may include a display 1200 (e.g., the display module 160 of FIG. 1).

According to an embodiment, the processor 340 may display the UI 125 on the display 1200. The UI 1250 may indicate whether audio data included in the moving image file is data (e.g., the first audio data 610) obtained from the external electronic device 400 or data (e.g., the internal audio data 1201 described with reference to FIG. 12A) obtained via the microphone 320.

Referring to FIG. 12B, the processor 340 may display a preview moving image on the display 1200 while first video data is obtained. The processor 340 may display the UI 1250 on a specified area in a preview moving image 1251 displayed on the display 1200. For example, the processor 340 may display the UI 1250 including characters “Ear phone” and “Mic” on the display 1200, and may display it such that any one of the characters “Ear phone” and “Mic” is emphasized (e.g., so as to have different colors, fonts, highlighting, etc.). The processor 340 may display the character “Ear phone” in the UI 1250 so as to be emphasized in a section in which a moving image file is created based on the first audio data 610 obtained from the external electronic device 400. The processor 340 may display the character “Mic” in the UI 1250 so as to be emphasized in a section in which a moving image file is created based on the internal audio data 1201 obtained by using the microphone 320. However, the illustration and description on the UI 1250 are only an example, and various embodiments implementable by ordinarily skilled in the art are possible. For example, the processor 340 may alternately display only any one of “Ear phone” and “Mic”, or may replace “Ear phone” or “Mic” with another word (e.g., headphones, earbuds, etc.), or may display on the display 120 the UI 1250 including icons or symbols rather than characters.

In another embodiment, the processor 340 may create the moving image file, based on any one of the first audio data 610 and internal audio data (e.g., the internal audio data 1201 described with reference to FIG. 12A) together with first video data, in response to receiving of a user input for the UI 1250 displayed on the display 1200. For example, the processor 340 may create a moving image file, based on the first video data and the first audio data 610, in response to receiving of a touch input for “Ear phone” in the UI 1250, and may create a moving image file, based on the first video data and the internal audio data, in response to receiving of a touch input for “Mic” in the UI 1250.

An electronic device according to an embodiment may include a camera, a microphone, a wireless communication circuit transmitting and receiving data with respect to an external electronic device, and at least one processor operatively coupled to the camera, the microphone, and the wireless communication circuit. The at least one processor may obtain first video data by using the camera, obtain first reference data depending on a first schedule during a first time duration by using a microphone, receive first audio data corresponding to the first video data from the external electronic device via the wireless communication circuit, change the first schedule to a second schedule, based on a comparison result between the first reference data and a portion of the first audio data, obtain second reference data depending on the second schedule during a second time duration subsequent to the first time duration by using the microphone, correct a delay of the first audio data, based on the second reference data, and create a moving image file, based on the first video data and the corrected first audio data.

In the electronic device according to an embodiment, the external electronic device may include a first ear bud and a second ear bud. The at least one processor my receive the first audio data corresponding to the first video data from the first ear bud via the wireless communication circuit, and receive second audio data corresponding to the first video data from the second ear bud via the wireless communication circuit.

In the electronic device according to an embodiment, the at least one processor may correct the delay of each of the first audio data and the second audio data, based on the second reference data, and create the moving image file, based on the first video data, the corrected first audio data, and the corrected second audio data.

In the electronic device according to an embodiment, the first schedule may include an interval and duration which enables the microphone. The second schedule may differ from the first schedule in that at least one of the interval or the duration is changed.

In the electronic device according to an embodiment, the at least one processor may analyze a correlation between the second reference data and the first audio data, identify a time by which the first audio data is delayed compared to the second reference data, based on a correlation analysis result, and correct the delay of the first audio data, based on the delayed time.

In the electronic device according to an embodiment, the at least one processor may apply a first noise filter to the first reference data, apply a second noise filter to the first audio data, analyze a correlation between the portion of the first audio data to which the second noise filter is applied and the first reference data to which the first noise filter is applied, determine whether the correlation analysis result satisfies a specified condition, correct the delay of the first audio data, based on the first reference data to which the first noise filter is applied, in response that the correlation analysis result satisfies the specified condition, and change the first schedule to the second schedule, in response that the correlation analysis result does not satisfy the specified condition.

In the electronic device according to an embodiment, the external electronic device may include a first external microphone and a second external microphone. The at least one processor may receive, via the wireless communication circuit, the first audio data obtained by the external electronic device by using the first external microphone and second audio data obtained by the external electronic device by using the second external microphone, wherein the first audio data and the second audio data correspond to the first video data, and analyze a correlation between the second reference data and each of the first audio data and the second audio data.

In the electronic device according to an embodiment, the at least one processor may select any one of audio data satisfying a specified condition from the first audio data and the second audio data, based on the correlation analysis result, and create the moving image file, based on the first video data and the selected audio data.

In the electronic device according to an embodiment, the at least one processor may select any one of audio data satisfying a specified condition from among the first audio data and the second audio data, based on the correlation analysis result, identify a time by which the selected audio data is delayed compared to the second reference data, and correct the first audio data and the delay of the second audio data, based on the delayed time.

In the electronic device according to an embodiment, the at least one processor may analyze a correlation between the second reference data and the first audio data, determine whether the correlation analysis result satisfies a specified condition, correct the delay of the first audio data, based on the second reference data to create the moving image file, based on the first video data and the corrected first audio data, in response that the correlation analysis result satisfies the specified condition, and obtain internal audio data corresponding to the first video data by using the microphone to create the moving image file, based on the first video data and the internal audio data, in response that the correlation analysis result does not satisfy the specified condition.

In the electronic device according to an embodiment, the electronic device may further include a display operatively coupled to the at least one processor. The at least one processor may display, on the display, a User Interface (UI) indicating whether audio data included in the moving image picture is obtained from the external electronic device or obtained via the microphone.

A method of operating an electronic device according to an embodiment may include obtaining first video data by using a camera included in the electronic device, obtaining first reference data depending on a first schedule during a first time duration by using a microphone included in the electronic device, receiving first audio data corresponding to the first video data from an external electronic device via a wireless communication circuit included in the electronic device, changing the first schedule to a second schedule, based on a comparison result between the first reference data and a portion of the first audio data, obtaining second reference data depending on the second schedule during a second time duration subsequent to the first time duration by using the microphone, correcting a delay of the first audio data, based on the second reference data, and creating a moving image file, based on the first video data and the corrected first audio data.

In the method of operating the electronic device according to an embodiment, the changing of the first schedule to the second schedule may include at least one of changing an interval for enabling the microphone and changing a duration for enabling the microphone.

In the method of operating the electronic device according to an embodiment, the correcting of the delay of the first audio data, based on the second reference data, may include analyzing a correlation between the second reference data and the first audio data, identifying a time by which the first audio data is delayed compared to the second reference data, based on a correlation analysis result, and correcting the delay of the first audio data, based on the delayed time.

In the method of operating the electronic device according to an embodiment, the comparing of the first reference data and the portion of the first audio data may include applying a first noise filter to the first reference data, applying a second noise filter to the first audio data, analyzing a correlation between the portion of the first audio data to which the second noise filter is applied and the first reference data to which the first noise filter is applied, determining whether the correlation analysis result satisfies a specified condition, correcting the delay of the first audio data, based on the first reference data to which the first noise filter is applied, in response that the correlation analysis result satisfies the specified condition, and changing the first schedule to the second schedule, in response that the correlation analysis result does not satisfy the specified condition.

An electronic device according to an embodiment may include a camera, a microphone, a wireless communication circuit transmitting and receiving data with respect to an external electronic device including a first external microphone and a second external microphone, and at least one processor operatively coupled to the camera, the microphone, and the wireless communication circuit. The at least one processor may obtain first video data by using the camera, obtain reference data depending on a specified schedule by using the microphone, receive first audio data corresponding to the first video data from the external electronic device via the wireless communication circuit, correct a delay of the first audio data, based on a comparison result between the first audio data and the reference data, and create a moving image file, based on the first video data and the corrected first audio data.

In the electronic device according to an embodiment, the specified condition may include an interval and duration for enabling the microphone.

In the electronic device according to an embodiment, the at least one processor may disable the microphone during a time not included in the duration.

In the electronic device according to an embodiment, the at least one processor may receive a user input for starting moving image capturing from a user, control the camera to obtain first video data, and transmit a signal for controlling the external electronic device to obtain the first audio data via the wireless communication circuit.

In the electronic device according to an embodiment, the at least one processor may receive a user input for stopping moving image capturing from a user, control the camera to stop obtaining of the first video data, and transmit a signal for controlling the external electronic device to stop obtaining of the first audio data via the wireless communication circuit.

1. An electronic device comprising:
a camera;
a microphone;
a wireless communication circuit transmitting and receiving data with respect to an external electronic device;
at least one processor; and
memory storing instructions that, when executed by the at least one processor, cause the electronic device to:
obtain first video data by using the camera;
obtain first reference data during a first time duration by using the microphone enabled according to a first schedule;
receive first audio data corresponding to the first video data from the external electronic device via the wireless communication circuit;
change the first schedule to a second schedule for enable the microphone, based on a comparison result between the first reference data and a portion of the first audio data;
obtain second reference data during a second time duration subsequent to the first time duration by using the microphone enabled according to the second schedule;
correct a delay of the first audio data based on the second reference data to generate corrected audio data; and
create a moving image file, based on the first video data and the corrected first audio data.

2. The electronic device of claim 1,
wherein the external electronic device includes a first ear bud and a second ear bud, and
wherein the instructions cause the electronic device to:
receive the first audio data corresponding to the first video data from the first ear bud via the wireless communication circuit; and
receive second audio data corresponding to the first video data from the second ear bud via the wireless communication circuit.

3. The electronic device of claim 2, wherein the instructions cause the electronic device to:
correct a delay of each of the first audio data to generate the corrected first audio data and the second audio data to generate a corrected second audio data, based on the second reference data; and
create the moving image file, based on the first video data, the corrected first audio data, and the corrected second audio data.

4. The electronic device of claim 1,
wherein the first schedule includes an interval and duration which enables the microphone, and
wherein the second schedule differs from the first schedule in that at least one of the interval or the duration is changed.

5. The electronic device of claim 1, wherein the instructions cause the electronic device to:
analyze a correlation between the second reference data and the first audio data;
identify a time by which the first audio data is delayed compared to the second reference data, based on a correlation analysis result; and
correct the delay of the first audio data, based on the delayed time.

6. The electronic device of claim 1, wherein the instructions cause the electronic device to:
apply a first noise filter to the first reference data;
apply a second noise filter to the first audio data;
analyze a correlation between the portion of the first audio data to which the second noise filter is applied and the first reference data to which the first noise filter is applied;
determine whether a correlation analysis result satisfies a specified condition;
correct the delay of the first audio data based on the first reference data to which the first noise filter is applied, in response that the correlation analysis result satisfies the specified condition; and
change the first schedule to the second schedule in response that the correlation analysis result does not satisfy the specified condition.

7. The electronic device of claim 1,
wherein the external electronic device includes a first external microphone and a second external microphone, and
wherein the instructions cause the electronic device to:
receive, via the wireless communication circuit, the first audio data obtained by the external electronic device by using the first external microphone and second audio data obtained by the external electronic device by using the second external microphone, wherein the first audio data and the second audio data correspond to the first video data; and
analyze a correlation between the second reference data and each of the first audio data and the second audio data.

8. The electronic device of claim 7, wherein the instructions cause the electronic device to:
select any one of audio data satisfying a specified condition from the first audio data and the second audio data, based on a correlation analysis result; and
create the moving image file based on the first video data and the selected audio data.

9. The electronic device of claim 7, wherein the instructions cause the electronic device to:
select any one of audio data satisfying a specified condition from among the first audio data and the second audio data, based on a correlation analysis result;
identify a time by which the selected audio data is delayed compared to the second reference data; and
correct the first audio data and the delay of the second audio data, based on the delayed time.

10. The electronic device of claim 1, wherein the instructions cause the electronic device to:
analyze a correlation between the second reference data and the first audio data;
determine whether a correlation analysis result satisfies a specified condition;
correct the delay of the first audio data, based on the second reference data to create the moving image file based on the first video data and the corrected first audio data, in response that the correlation analysis result satisfies the specified condition; and
obtain internal audio data corresponding to the first video data by using the microphone to create the moving image file based on the first video data and the internal audio data, in response that the correlation analysis result does not satisfy the specified condition.

11. The electronic device of claim 10, further comprising
a display operatively coupled to the at least one processor,
wherein the instructions cause the electronic device to display, on the display, a User Interface (UI) indicating whether audio data included in a moving image picture is obtained from the external electronic device or obtained via the microphone.

12. A method of operating an electronic device, the method comprising:
obtaining first video data by using a camera included in the electronic device;
obtaining first reference data during a first time duration by using a microphone enabled according to a first schedule included in the electronic device;
receiving first audio data corresponding to the first video data from an external electronic device via a wireless communication circuit included in the electronic device;
changing the first schedule to a second schedule for enable the microphone, based on a comparison result between the first reference data and a portion of the first audio data;
obtaining second reference data during a second time duration subsequent to the first time duration by using the microphone enabled according to the second schedule;
correcting a delay of the first audio data based on the second reference data to generate corrected audio data; and
creating a moving image file, based on the first video data and the corrected first audio data.

13. The method of claim 12, wherein the changing of the first schedule to the second schedule comprises at least one of changing an interval for enabling the microphone and changing a duration for enabling the microphone.

14. The method of claim 12, wherein the correcting of the delay of the first audio data, based on the second reference data, comprises:
analyzing a correlation between the second reference data and the first audio data;
identifying a time by which the first audio data is delayed compared to the second reference data, based on a correlation analysis result; and
correcting the delay of the first audio data, based on the delayed time.

15. The method of claim 12, wherein the comparing of the first reference data and the portion of the first audio data comprises:
applying a first noise filter to the first reference data;
applying a second noise filter to the first audio data;
analyzing a correlation between the portion of the first audio data to which the second noise filter is applied and the first reference data to which the first noise filter is applied;
determining whether a correlation analysis result satisfies a specified condition;
correcting the delay of the first audio data, based on the first reference data to which the first noise filter is applied, in response that the correlation analysis result satisfies the specified condition; and
changing the first schedule to the second schedule, in response that the correlation analysis result does not satisfy the specified condition.

16. An electronic device comprising:
a camera;
a microphone;
a wireless communication circuit transmitting and receiving data with respect to an external electronic device;
at least one processor; and
memory storing instructions that, when executed by the at least one processor, cause the electronic device to:
obtain video data by using the camera;
obtain reference data during a time duration by using the microphone enabled according to a schedule;
receive audio data corresponding to the video data from the external electronic device via the wireless communication circuit;
perform a correlation analysis using the at least one processor to correct a delay of the audio data based at least in part on the reference data; and
create a moving image file based at least in part on the video data and the corrected audio data.

17. The electronic device of claim 16, wherein the correlation analysis comprises:
applying by the electronic device a first noise filter to the reference data to generate filtered reference data;
applying by the electronic device a second noise filter to the audio data to generate filtered audio data;
analyzing a correlation between the filtered reference data and the filtered audio data; and
correcting the delay of the audio data based on the correlation.

18. The electronic device of claim 17, wherein the correlation analysis further comprises:
determining by the electronic device a time difference between the filtered audio data and the filtered reference data; and
removing the time difference to correct the delay of the audio data.

19. The electronic device of claim 18, wherein removing the time difference comprises:
identifying at least one reference signal pattern occurring at a first time period in the filtered reference data;
identifying at least one audio signal pattern occurring at a different second time period included in the filtered audio data;
synchronizing the second time period of the at least one audio signal pattern to match the first time period of the at least one reference signal pattern to remove the time difference.

20. The electronic device of claim 16, wherein the audio data includes first audio data corresponding to the video data obtained from a first audio output device, and second audio data corresponding to the video data obtained from a second audio output device.
